(19) United States
(12) Patent Application Publication
(10) Pub. No.: US 2010/0091659 A1
(43) Pub. Date: Apr. 15, 2010

(54) Computer networks

(76) Inventors: Shane O'Hanlon, Kildare (IE); Samuel Liddicott, Wakefield (GB)

Correspondence Address: SMYRSKI LAW GROUP, A PROFESSIONAL CORPORATION, 3310 AIRPORT AVENUE, SW, SANTA MONICA, CA, 90405, US

(21) Appl. No.: 12/290,591

(22) Filed: Oct. 31, 2008

(30) Foreign Application Priority Data
Oct. 9, 2008 (GB) GB 0818506.8

(51) Int. Cl. H04L 12/26; H04L 12/28

(52) U.S. Cl. 370/241; 370/255

(57) ABSTRACT

A computer implemented method for analysing a connection between two computers. The method comprises generating output data indicating performance of the connection, the output data comprising a first predetermined number of data points, each data point having a value selected from a second predetermined number of discrete data values.

This application claims priority to Great Britain Patent Application No. GB 0818506.8, filed on Oct. 9, 2008, which is incorporated herein by reference in its entirety.

The present invention relates to methods and apparatus suitable for use in computer networks. More particularly, but not exclusively, the invention relates to methods for analysing connections between computers in a computer network.

Computers are commonplace in modern society. Computers are often connected together by way of a computer network so as to allow data to be transmitted between the computers. For example, many companies and other organisations connect their computers together so as to allow those computers to access common resources such as file servers and printers, and further so as to allow users of the computers to transmit data to one another, for example by way of email messages.

Many computers are now connected to the worldwide network known as the Internet. Computers which are connected to a local area network can often access the Internet via a server connected to the local area network which is itself connected to the Internet and can therefore provide Internet connectivity. Home users may connect to the Internet using dialup connections to connect to a server providing Internet connectivity, or alternatively via a so-called “broadband” connection providing increased bandwidth and therefore shorter transmission times.

The use of computer networks has brought great improvements in efficiency for organisations, and allows individuals to access a wealth of information from their homes or offices. However, the sheer quantity of information which is now available means that there are increasing demands on computer networks in terms of bandwidth, so as to allow large quantities of data to be quickly transferred. Such demands are particularly acute when users wish to access media content which is typically provided in relatively large files which require relatively high bandwidth connections if they are to be transferred across a computer network quickly.

The foregoing concerns have led to proposals being made for systems that allow network engineers to analyse various parts of a computer network so as to identify bottlenecks which result in data transfer rates being reduced. Such systems typically allow a user to specify a degree to which it is desired to analyse the network. A finer analysis typically requires more data to be stored and also requires more processing to be carried out such that a more powerful computer is required unless the analysis is to take longer. A coarser analysis typically requires less data and can be carried out more quickly. Some techniques providing a relatively detailed analysis involve capturing each data packet that traverses a network either in whole or part, and then performing a post event analysis based upon the captured data packets. For a coarser analysis statistical data relating to the network traffic is sometimes stored.

The systems described above are often disadvantageous in that obtaining a desired degree of analysis often requires too much data to be stored and/or requires excessive processing resources. It is to be noted that the processing resources which are available may be limited to those included in a switch in the network which is being analysed.

For example, where information about each packet transmitted across the network is stored the technique becomes cumbersome if not ineffective. Powerful computers are required to analyse the data, and the large amounts of data involved can cause errors such as running out of memory. Implementation of such a solution is costly as large storage area networks are typically required. As this type of analysis is usually carried out post event, a problem identified by the analysis may have passed by the time the results of the analysis are available such that corrective action can no longer be effectively taken.

While the storage of statistical data relating to the network traffic avoids some of the problems outlined above and provides a more cost effective solution, such statistical data often provides insufficient information to allow a network engineer to make a proper judgement as to the cause of a problem, and identify a suitable solution.

It is an object of embodiments of the present invention to obviate or mitigate at least some of the above-mentioned drawbacks.

According to the present invention, there is provided a method for analysing a connection between two computers, the method comprising generating output data indicating performance of the connection, the output data comprising a first predetermined number of data points, each data point having a value selected from a predetermined second number of discrete data values.

Each data point represents a corresponding flow value that is the amount of data, relative to a maximum amount of data. As time passes, and length of a connection of increases scaling is performed so that the fixed number of data points store information representative of the entire connection.

The generating may comprise storing a third number of initial values, each initial value indicating a quantity of data passing between said two computers in a predetermined time period. The generating may further comprise processing said third number of stored initial values to compute a fourth number of processed values wherein said fourth number is smaller than said third number. The fourth number may be equal to said first predetermined number.

Computing each of said fourth number of processed values may comprise computing an average value based upon a plurality of said stored initial values. Computing said fourth number of processed values may further comprise determining a first scaling factor and determining a relationship between each of said average values and said first scaling factor.

Determining a first scaling factor may comprise determining a maximum value and determining a relationship between said maximum value and the second predetermined number of discrete data values. The output data may further comprise said first scaling factor.

The method may further comprise storing a fifth number of further initial data values and computing modified processed values based upon said processed values and said further initial data values. Said fifth number may be equal to said fourth number.

Computing modified processed values based upon said processed values and said further initial data values may comprise processing said further initial data values to determine a second scaling factor, computing a modified scaling factor based upon at least one first scaling factor associated with said processed values and said second scaling factor and determining a relationship between a plurality of said processed values and said further initial data values and said modified scaling factor.

The relationship may be based upon an average of a plurality of said processed values and said further initial data values. Computing a modified scaling factor may be based upon an average of a plurality of first scaling factors and said second scaling factor.

Computing a modified scaling factor based upon said first scaling factor and said second scaling factor may comprise determining a weight based upon a relationship between said first scaling factor and said second scaling factor and computing a weighted average of said first scaling factor and said second scaling factor based upon said weight.

Computing the modified scaling factor may comprise applying said weight to one of said first scaling factor and said second scaling factor to produce a weighted scaling factor such that the weighted scaling factor is of substantially the same magnitude as the other of said first scaling factor and said second scaling factor.

The relationship between said first scaling factor and said second scaling factor may be based upon division of one of said first scaling factor and said second scaling factor divided by the other of said first scaling factor and said second scaling factor. The weight may be applied to the smaller of said first scaling factor and said second scaling factor.

Determining a relationship between a plurality of said fourth number of processed values and said further initial data values and said modified scaling factor may comprise computing further processed data values based upon a relationship between said processed values and said first scaling factor, computing a plurality of average values, each average value being based upon a plurality of said further processed values or a plurality of said further initial data values and determining a relationship between each average value and said modified scaling factor.

The method may further comprise storing said first scaling factor in a memory location and overwriting said first scaling factor with said modified scaling factor. The method may further comprise storing said fourth number of processed data values in a memory location and overwriting said fourth number of processed data values with said modified processed data values. The method may further comprise repeating the steps of storing a predetermined number of further initial data values and computing modified processed values based upon said fourth number of processed values and said further initial data values.

The predetermined number of processed values may be the same as said predetermined number of further initial data values. At least one of said data points may have a value indicative of said predetermined second number of discrete data values. The output data may be a graphical representation of said data. The output data may comprise a value indicative of said data points and data values and said data points and data values can be retrieved by a lookup table.

The invention also provides a method for identifying an anomalous connection in a plurality of connections, the method comprises analysing each of said plurality of connections using a method as set out above to generate respective output data for each of the plurality of connections, and identifying said anomalous connection by processing said output data.

Identifying said anomalous output data may comprise comparing peak values of the output data associated with each of said plurality of connections.

The invention also provides a method for generating data identifying a preferred configuration for a network, the method comprising configuring the network according to a first configuration, analysing the network configured according to the first configuration using a method as set out above, configuring the network according to a second configuration, analysing the network configured according to the second configuration using a method according to the first embodiment of the invention to generate second output data and processing said first and second output data to generate said data identifying the preferred configuration.

The methods as described above may further comprise receiving a plurality of data packets associated with said connection and processing said data packets to generate data indicating a quantity of data transferred using said connection.

According to a second aspect of the invention there is provided a method for transferring data from a first computer to a second computer, the method comprising determining a checksum of a data item to be transmitted, processing said data item to be transmitted to generate a plurality of secondary data items, determining a plurality of secondary checksums, one for each secondary data item, transmitting said checksum and said secondary checksums from said first computer to said second computer, such that said second computer can identify said data item based upon said checksum and secondary checksums.

The method may further comprise storing, at the first computer, a record for said data item, said record comprising said checksum of said data item and said plurality of secondary checksums. The record may further comprise a value indicating the number of times said data item has been transmitted to said second computer.

Transmitting said checksum and said secondary checksums may comprise determining, at the first computer, whether said data item should be sent to said second computer based upon said value indicating the number of times said data item has been transmitted to said second computer, transmitting said data item to said second computer if it is determined that said data item should be transmitted to said second computer and transmitting said checksum and said secondary checksums to said second computer when it is determined that said data item should not be transmitted to said second computer.

According to a third aspect of the present invention there is provided a method for receiving data at a second computer from a first computer, the method comprising receiving a checksum of a data item, receiving a plurality of secondary checksums and identifying said data item based upon said checksum and secondary checksums.

The method may further comprise storing a record for a received data item, said record comprising a checksum of said data item and a plurality of secondary checksums. The record may further comprise a value indicating the number of times said data item has been received from said first computer.

Identifying said data item based upon said checksum and secondary checksums may comprise determining whether said data item is stored based upon said value indicating the number of times said data has been received and requesting said data item from said first computer dependent upon said determining.

According to a further aspect of the invention there is provided a method for receiving data, the method comprising receiving data, receiving error correction data associated with the received data, receiving secondary data associated with the received data, processing said data and said error correction data to identify at least one error in the received data, and determine at least one correction to said error and processing said secondary data to determine whether said at least one correction should be made.

The secondary data may comprise a checksum for said data. The method may further comprise determining a further correction to said error based upon said secondary data and said error correction data if it is determined said at least one correction should not be made. The error correction data may comprise an ordered list of corrections and determining a further correction comprises selecting the next correction in said ordered list. The received data may be hamming encoded and the further correction may be determined by the next smallest hamming distance.

The invention may be implemented using a computer program comprising computer readable instructions configured to cause a computer to carry out a method as set out above. The invention may also be implemented as a computer readable medium carrying such a computer program. The invention further provides apparatus for carrying out any of the embodiments of the invention.

Embodiments of various aspects of the present invention will now be described, by way of example only, with reference to the accompanying drawings, in which:

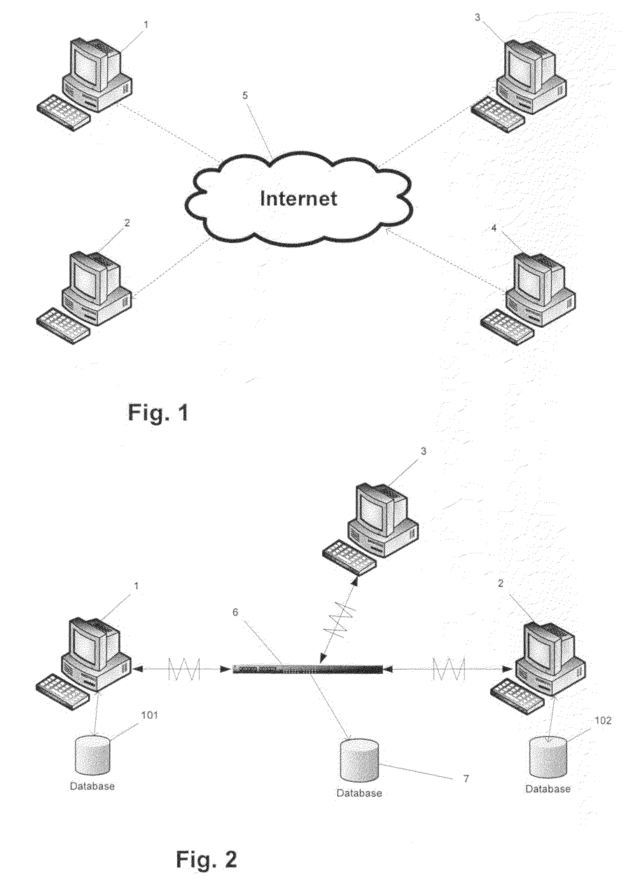

FIG. 1 is a schematic illustration of a network of computers connected together via the Internet;

FIG. 2 is a schematic illustration showing connections between three of the computers of FIG. 1 through a switch in further detail;

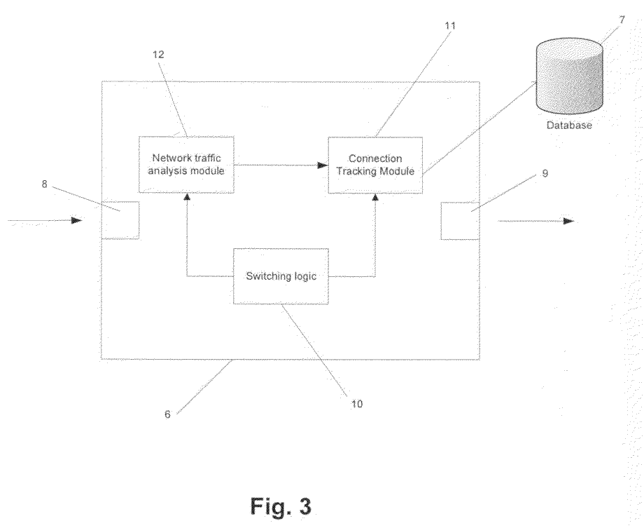

FIG. 3 is a schematic illustration showing the switch of FIG. 2 in further detail;

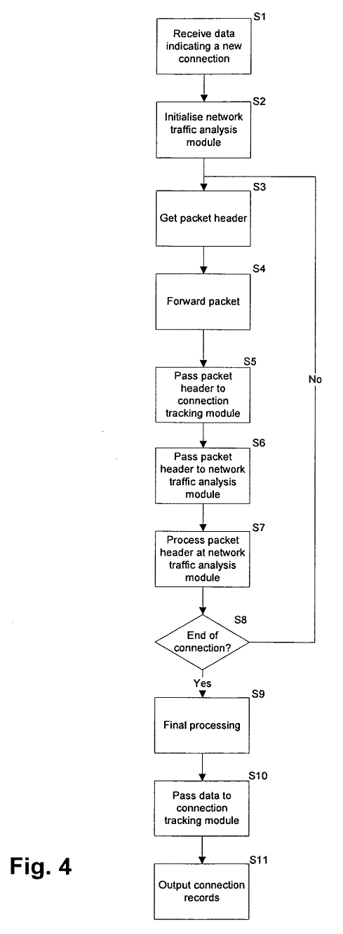

FIG. 4 is a flowchart showing processing carried out by the switch of FIG. 3 in accordance with an embodiment of the invention;

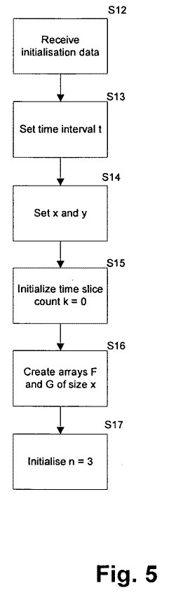

FIG. 5 is a flowchart showing processing for initialising a network traffic analysis algorithm used in the processing of FIG. 4;

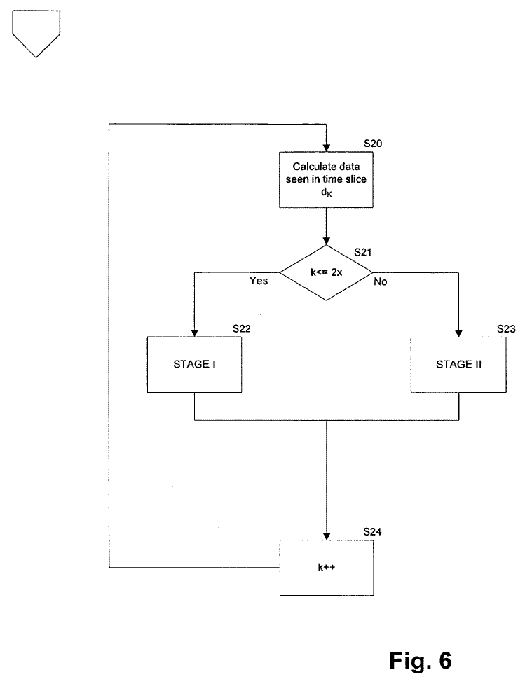

FIG. 6 is a flowchart showing processing of the network traffic analysis algorithm in further detail;

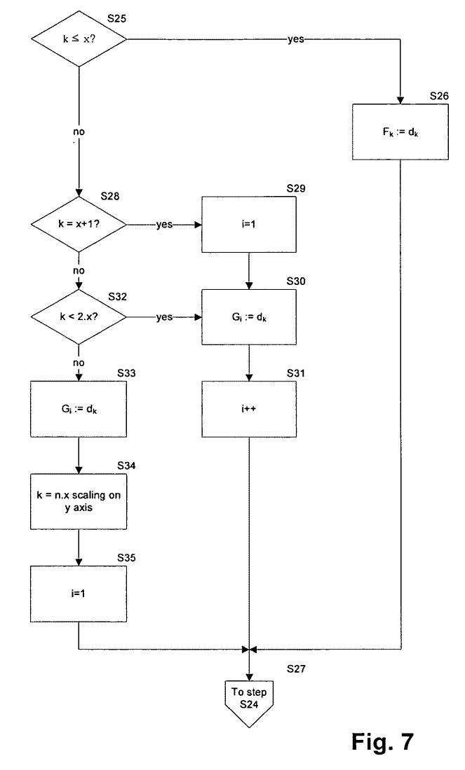

FIG. 7 is a flowchart showing part of the processing of FIG. 6 in further detail;

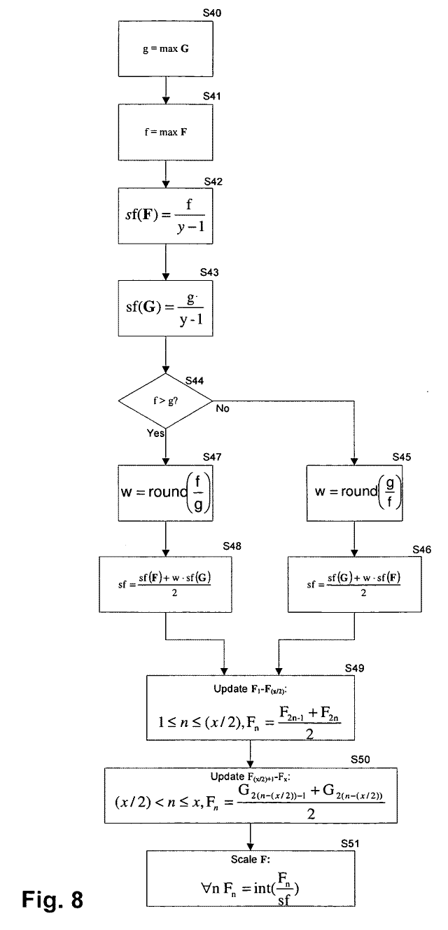

FIG. 8 is a flowchart showing part of the processing of FIG. 7 in further detail;

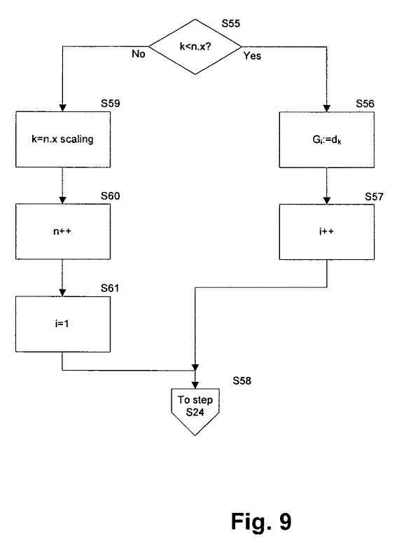

FIG. 9 is a flowchart showing part of the processing of FIG. 6 in further detail;

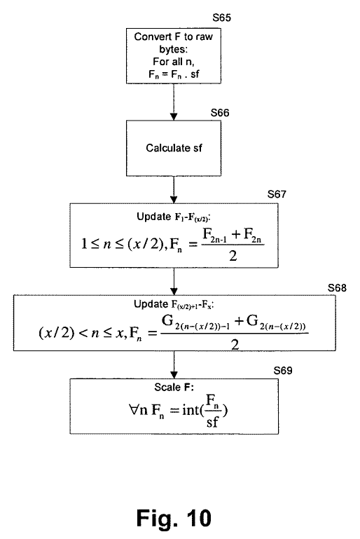

FIG. 10 is a flowchart showing part of the processing of FIG. 9 in further detail;

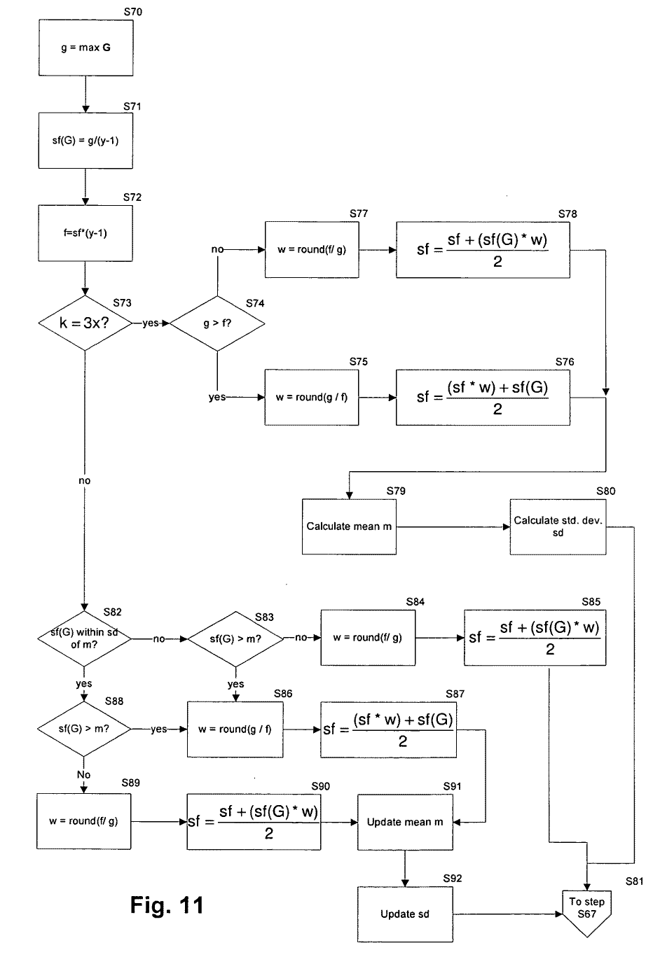

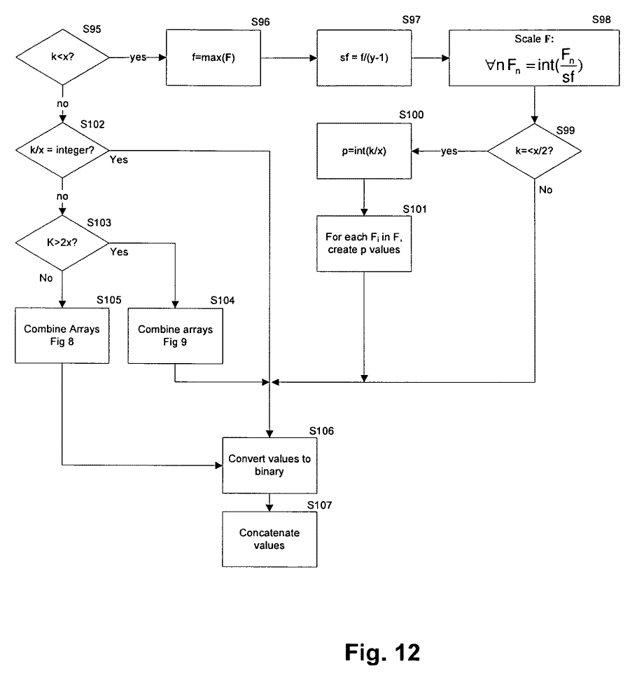

FIG. 11 is a flowchart showing part of the processing of FIG. 10 in further detail;

FIG. 12 is a flowchart showing part of the processing of FIG. 4 in further detail;

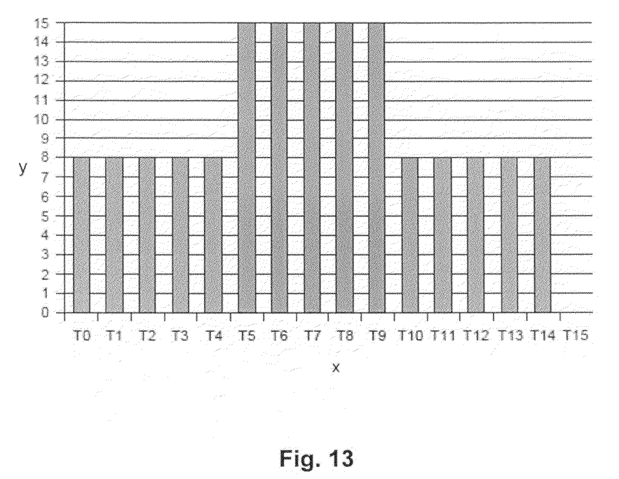

FIG. 13 is a graph showing an example of values output by the network traffic analysis algorithm used in the processing of FIG. 4;

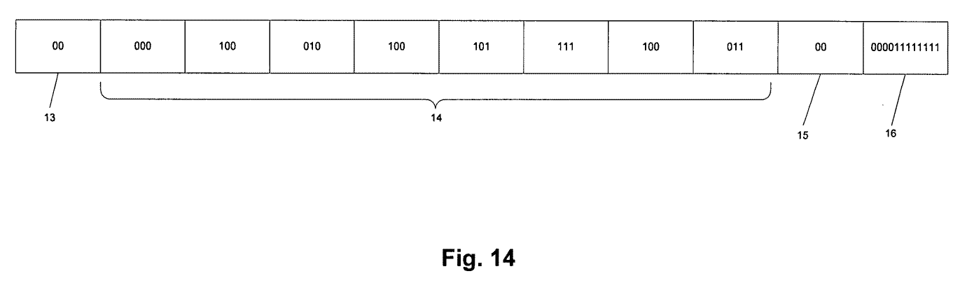

FIG. 14 is a schematic illustration of data output by the processing of FIG. 4;

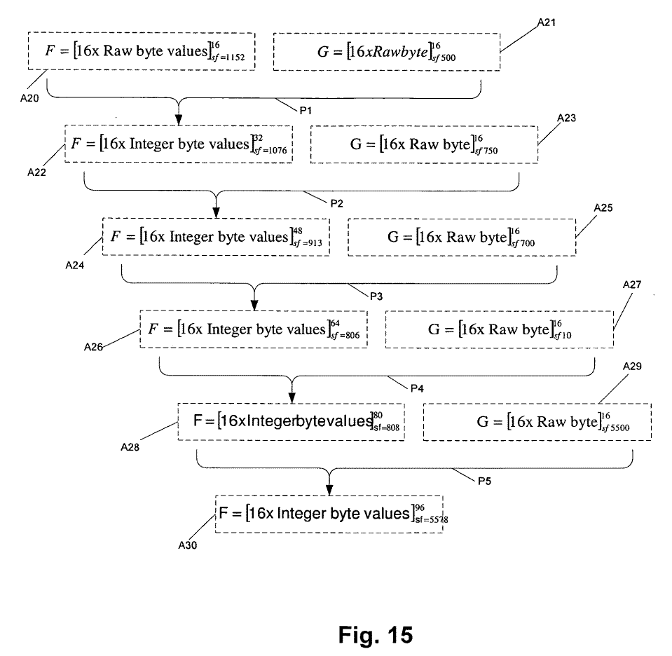

FIG. 15 is a schematic illustration of an example of processing carried out in FIG. 6;

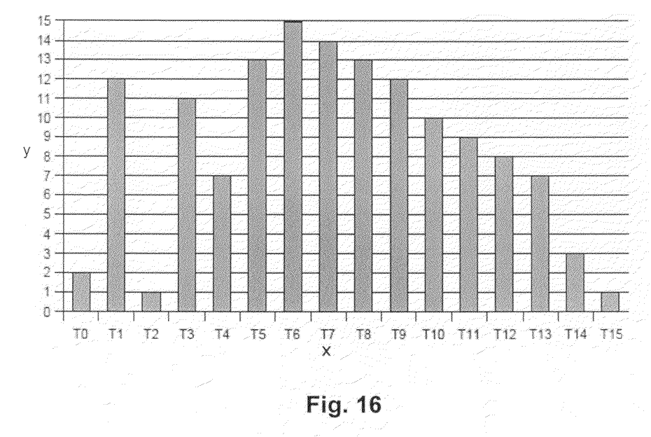

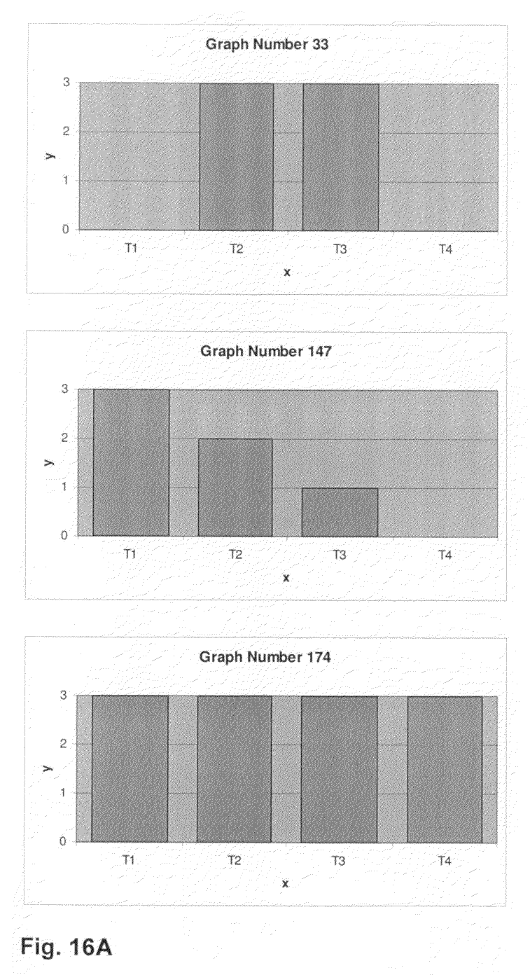

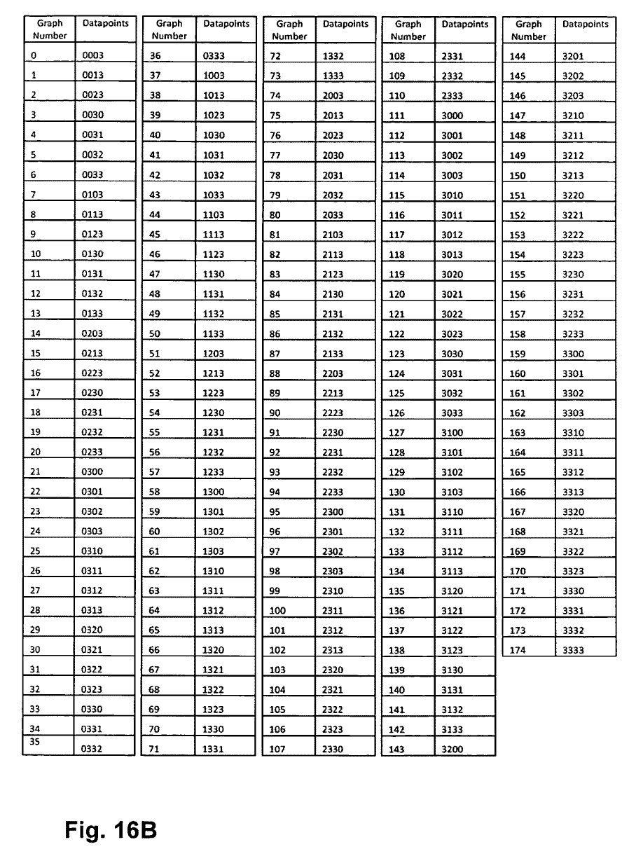

FIG. 16 is a graph showing a further example of values output by the network traffic analysis algorithm used in the processing of FIG. 4;

FIG. 16A is three possible graph numbers and the graphs they represent;

FIG. 16B is an example look up table for looking up graph numbers and corresponding data points;

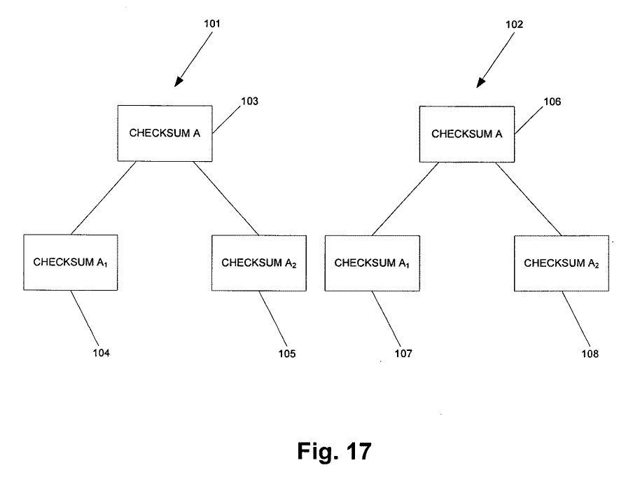

FIG. 17 is a schematic illustration of checksums used in an embodiment of the invention;

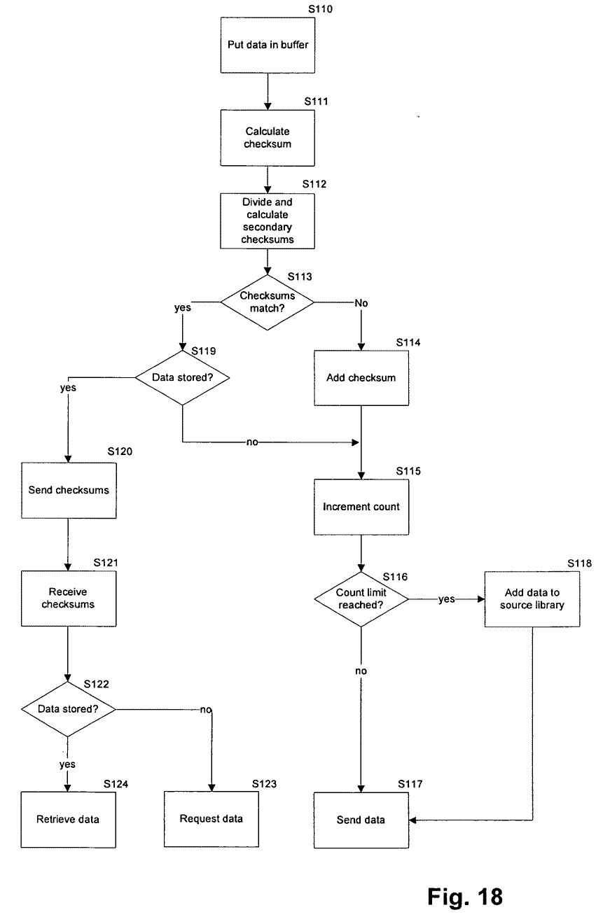

FIG. 18 is a flowchart showing how the checksums of FIG. 17 can be used by a first computer when transmitting data to a second computer;

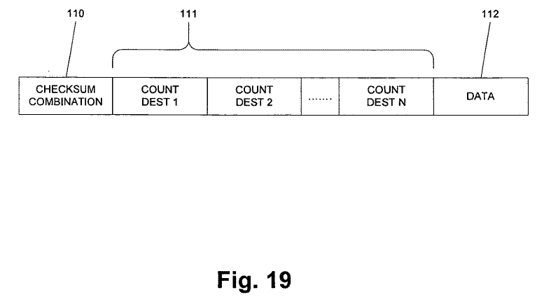

FIG. 19 is a schematic illustration of data stored in a database associated with one of the computers of FIG. 2;

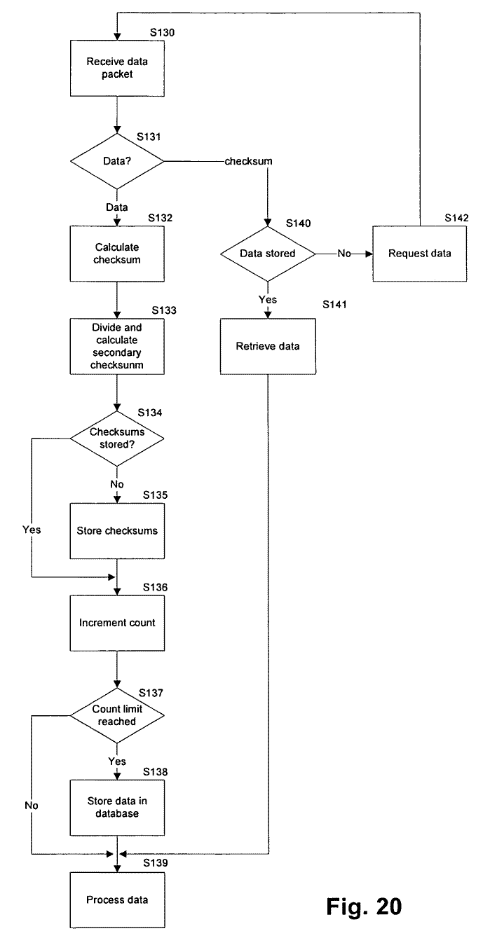

FIG. 20 is a flowchart showing how the checksums of FIG. 17 can be used by a second computer when receiving data from a first computer;

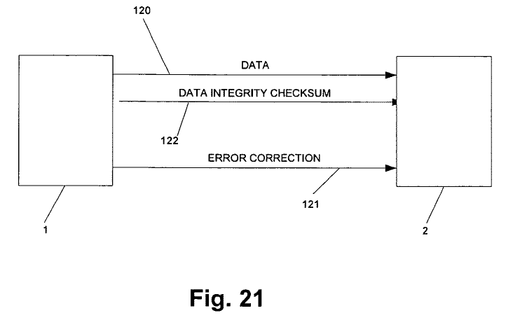

FIG. 21 is a schematic illustration of a transfer of data between two computers; and

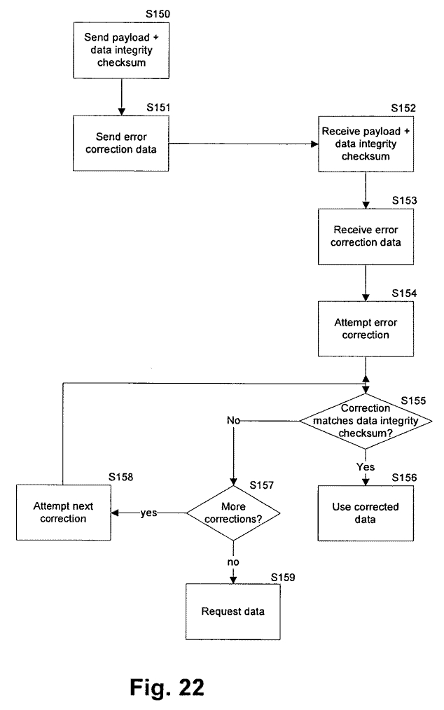

FIG. 22 is a flowchart showing processing associated with the transfer of data schematically illustrated in FIG. 21.

Referring now to FIG. 1, computers 1, 2, 3, 4 are arranged to communicate with each other over the Internet 5. Each computer is connected to the Internet by any suitable means. For example, some or all of the computers 1, 2, 3, 4 may be connected to local area networks. Servers providing Internet connectivity may also be connected to the local area networks and the computers 1, 2, 3, 4 can therefore access the Internet 5 through the servers.

Referring now to FIG. 2, connections between the three computers 1, 2, 3 through the Internet 2 are shown in further detail. It can be seen that each of the computers 1, 2, 3 is connected to a switch 6. In this way data can be routed between the computers 1, 2, 3. The switch 6 is connected to a database 7. The database 7 is adapted to store data indicative of performance of the connections passing through the switch 6, as is described in further detail below.

Referring now to FIG. 3 operation of the switch 6 is described in further detail. The switch 6 has a plurality of ports. Each of the computers 1, 2, 3 is connected to a respective port. The computer 1 is connected to a port 8, while the computer 2 is connected to a port 9.

Data passes through the switch 6 in the form of data packets. For example, data packets created by the computer 1 and destined for the computer 2 are received by the switch 6 through the port 8, and routed by the switch 6 to the port 9 from where they are forwarded to the computer 2. Each data packet comprises data to be transmitted (sometimes referred to as a payload) together with a packet header comprising information about the data packet including data indicating the source and destination of the data packet, and data indicating the quantity of data within the data packet.

The switch comprises switching logic 10 which is arranged to process a received data packet and forward the received data packet to the appropriate output port. The switching logic 10 also processes received data packets to obtain information relating to the data packets which is forwarded to both a connection tracking module 11 and a network traffic analysis module 12, both of which are described in further detail below. Both the connection tracking module 11 and the network traffic analysis module 12 are arranged to generate data indicating the performance of a particular connection. In this context the term “connection” is used to refer to a particular transfer of data between two end points between a start time and an end time. A connection may take any convenient form, and may be, for example, a TCP/IP connection. For example, when a first computer requests download of data from a second computer and the second computer responds providing the data, the transfer of data from both the first computer to the second computer and the second computer to the first computer together constitute a connection. That is, a bidirectional flow of data between two computers may make up a connection.

The connection tracking module 11 receives data indicating data packets passed through the switch 6 during the course of a particular connection. The network traffic analysis module 12 also receives data indicating data packets passed through the switch 6, and processes this data to generate data which is useful in determining performance parameters associated with the connection. The network traffic analysis module 12 passes generated data to the connection tracking module 11 such that the data useful in determining performance parameters can be associated with data processed by the connection tracking module 11. The connection tracking module 11 stores data associated with a particular connection in the database 7.

Although the database 7 is shown external to the switch 6, it will be appreciated that in alternative embodiments of the invention the database 6 may be stored within a non-volatile storage device provided within the switch 6.

Operation of the various components of the switch 6 and the ways in which they interact during the course of a connection is now described in further detail, first with reference to FIG. 4.

At step S1 the switch 6 receives data indicating a new connection between a particular source and particular destination. At step S2 the network traffic analysis module is initialised to generate data associated with the new connection as described in further detail with reference to FIG. 5. It will be appreciated that initialisation can be carried out at any suitable stage at the beginning of a new connection.

At step S3 the switching logic 10 receives a data packet associated with the connection and extracts the packet header. Data that is extracted allows a particular connection to be uniquely identified, and may include the source and destination MAC addresses and Internet Protocol (IP) parameters such as source and destination IP addresses. The IP protocol parameters can be used to determine what further data should be extracted, for example TCP port numbers.

At step S4 the switching logic 10 forwards the data packet to a port of the switch 6 associated with the destination of the data packet. At step S5 the switching logic 10 forwards the extracted packet header to the connection tracking module 11 for use. The connection tracking module stores the parameters in the packet header, which can be used to identify a particular connection at a later date for example during analysis of the connection. At step S6 the switching logic 10 forwards the extracted packet header to the network traffic analysis module 12.

At step S7 the network traffic analysis module 12 receives the data packet header from the switching logic 10 and processes the received data packet header as described in further detail below with reference to FIGS. 6 to 11.

At step S8 a check is performed to determine if the currently processed connection is at an end. If the connection is not at an end, processing returns to step S3. If the connection is at an end processing passes to step S9 where final processing is carried out by the network traffic analysis module as described in detail below with reference to FIG. 12. At step S10 data is passed to the connection tracking module 11 from the network traffic analysis module 12. At step S11 the connection tracking module 11 outputs a connection record for the processed connection to the database 7.

Operation of the network traffic analysis module 12 is now described in further detail, first with reference to FIG. 5 which shows processing carried out at step S2 of FIG. 4.

Referring to FIG. 5, at step S12 the network traffic analysis module 12 receives initialisation data comprising a time interval t, a number of data points x and a number of data values y. It will be appreciated that the initialisation data received at step S12 may be input at the beginning of each connection or may be generated based upon predetermined values. The initialisation data is typically defined by an operator.

The time interval t indicates a time period over which data amounts passing through the switch 6 are measured. The time interval t will be set in dependence upon the expected length of a connection, with t being set as a longer period of time for longer connections. The time interval t is set at step S13, based upon the received initialisation data. In some embodiments of the invention the time interval t has a value of the order of one second.

The number of data points x indicates a number of data points to be included in data output from the network traffic analysis module 12 indicating performance of a processed connection. The number of data values y indicates a discrete number of values (in a range 0 to y−1) which each of the x data points in the output data may take. In a preferred embodiment the number of data values y is equal to the number of data points x. The number of data points x and the number of data values y are set at step S14 based upon the initialisation data received at step S12.

At step S15 the counter variable k indicating a number of time intervals (or time slices) that have passed is initialised to 0. At step S16 an array F of size x and an array G of size x are created. Data processed by the network traffic analysis module 12 is stored in the arrays F, G as is described in further detail below.

At step S17 a counter variable n is initialised to the value 3. The counter variable n indicates the number of arrays of size x that have been filled, from 3 upwards. Processing is carried out in a different way for the first two times the array is filled and the variable n is not used before 3.x time slices have been processed.

The processing carried out at step S7 of FIG. 4 is now described in further detail with reference to FIGS. 6 to 11.

Referring now to FIG. 6, at step S20 the amount of data seen in a k^{th} time slice dₖ is calculated as a byte value. This calculation is carried out by processing each data packet passing through the switch 6 in a time slice currently being processed to determine a size of those data packets. Data indicating data packet size may form part of the data packet header, such that the network traffic analysis module 12 may simply extract relevant data from each data packet header and add the extracted data values together to determine the quantity of data that has passed through the switch in the time slice.

At step S21 a test is performed to determine if the number of time slices processed k is less than or equal to twice the size of the array F (i.e. less than or equal to 2x). If it is determined that this is the case then processing continues at step S22 where processing referred to as stage I processing (which is described in further detail below with reference to FIGS. 7 and 8) is carried out. If it is determined that the number of time slices k is not less than or equal to twice the size of the array F processing continues at step S23, where processing referred to as stage II processing is carried out, as described further below with reference to FIGS. 9, 10 and 11.

Having processed the data obtained at step S20 at either step S22 or step S23, processing passes to step S24 where the value of k is incremented so as to reference a next time slice. In this way, the processing of FIG. 6 processes each time slice in turn.

Stage I processing, as is carried out at step S22 is now described in further detail with reference to FIG. 7.

At step S25 a test is performed to determine whether the value of k is less than or equal to x. It will be recalled that x indicates a number of data points stored in a single array. If this test is satisfied, processing passes to step S26 where the value dₖ is assigned to the kth element of the array F and processing continues at step S27 where processing returns to step S24 of FIG. 6. It can be appreciated that the processing of steps S25 and S26 of FIG. 7, together with the processing of step S24 of FIG. 6 results in data associated with each of the first x time slices being processed in turn, so that the array F includes byte values associated with each of the first x time slices.

If the test of step S25 indicates that the value of k is not less than or equal to x processing passes from step S25 to step S28. Here a further test is carried out to determine if k is equal to x+1. If it is determined that k is equal to x+1, then all the elements of the array F have been assigned a value and the currently processed time slice (x+1) is to be stored in a further array G. Processing therefore passes from step S28 to step S29 where a counter variable i for counting through the elements of the array G is initialised to 1. At step S30 the ith element of the array G is assigned to the value dₖ (i.e. the quantity of data which passed through the switch during the currently processed time slice k) and at step S31 the counter variable i is incremented. Processing then passes to step S27, before returning to step S24 of FIG. 6.

If k is not equal to x+1 at step S28 processing continues at step S32 where a further test is performed to determine if k is less than twice the value of x. If the check of step S32 is satisfied it can be deduced that there are elements in the array G which have not been assigned a value. Processing therefore continues at step S30 as described above where the ith element of the array G is assigned to the value dₖ (i.e. the quantity of data which passed through the switch during the currently processed time slice k).

If the check of step S32 is not satisfied it can be deduced that the value of k is equal to twice the value of x (given that the processing of FIG. 7 is only carried out if the check of step S21 is satisfied). In this case processing passes from step S32 to step S33 where the ith element of the array G is assigned to the value dₖ (i.e. the quantity of data which passed through the switch during the currently processed time slice k).

It can be seen that there are now two arrays F and G, each of size x, each element of each array storing a byte value corresponding to the amount of data seen in a time slice of length t. At step S34 the values in the arrays F and G are processed in the manner described below with reference to FIG. 8, before processing continues at step S35 where the value of i is reset to be 1, and then passes to step S27.

FIG. 8 shows the processing of step S34 of FIG. 7 in further detail, and is now described. At step S40 a variable g is assigned to the maximum value in the array G. At step S41 a variable f is assigned to the maximum value in the array F. At step S42 a scaling factor sf(F) is calculated for the array F by dividing f by one less than the number of data values,(i.e. dividing by y−1), while at step S43 a scaling factor sf(G) is calculated by dividing g by one less than the number of data values (i.e. dividing by y−1). The value y indicates the number of discrete values, in a range 0 to y−1, that can be taken by elements of the array F when the array F is output from the network traffic analysis module 12. It can be seen that the largest discrete integer value (i.e. y−1) which can be taken by an element of the array F when the array F is output from will always be one less than the number of discrete integer values (y) since zero is included in the range of integer values. It can therefore be seen that multiplying the value sj(F) by the largest discrete integer value (i.e. y−1) returns the value f.

In typical embodiments of the invention the value of y may have values such as 4, 8 or 16. As indicated above, x and y preferably have equal values. The calculated scaling factors for each of the arrays F and G are such that when the scaling factor is multiplied by the value of y−1 an approximation of the maximum value within the respective array is generated.

At step S44 a test is performed to determine if f is larger than g. If it is determined that this is not the case then processing continues at step S45 where a weight w is calculated by applying the function round to the value generated by dividing g by f where round is a function that rounds its argument to the nearest integer. At step S46 a further scaling factor sf is calculated according to equation (1) shown below.

$$sf = \frac{sf ( G ) + w \cdot sf ( F )}{2} \qquad ( 1 )$$

If the test of step S44 is satisfied processing continues at step S47 where a weight w is calculated by applying the function round to the value generated by dividing f by g. At step S48 a further scaling factor sf is calculated by equation (2) shown below.

$$sf = \frac{sf ( \cdot ) + w \cdot sf ( \cdot )}{2} \qquad ( 2 )$$

Processing passes from each of steps S46 and S48 to step S49 described below.

The scaling factors generated at each of steps S46 and S48 take the smallest of the scaling factors associated with the two arrays F and G and multiply this smallest scaling factor by the weight w. Given the way in which the weight w is calculated as described above, the value of the operand of the addition including the weight w will be of broadly similar magnitude to the other operand of the addition. As such, it can be seen that the value of the computed scaling factor is always biased to the larger of the scaling factors associated with the two arrays F and G, the biasing being in inverse proportion to the ratio between the scaling factors associated with the two arrays F and G.

At step S49 elements 1 to (x/2) of the array F are determined by equation (3) shown below:

$${F}_{n} = \frac{{F}_{2 n - 1} + {F}_{2 n}}{2} ∀ n \text{:} n \leq \frac{x}{2} \qquad ( 3 )$$

where Fₙ is the nth element of the array F.

At step S50 values (x/2+1) to x of the array F are calculated according to equation (4):

$${F}_{n} = \frac{{G}_{2 ( n - ( x / 2 ) ) - 1} + {G}_{2 ( n - ( x / 2 ) )}}{2} ∀ n \text{:} n > \frac{x}{2} \qquad ( 4 )$$

where Gₙ is the nth element of the array G.

It can be seen that after the processing of steps S49 and S50, each element of the array F stores a value representing the average amount of data in bytes seen over a time slice of length 2t.

At step S51 the values in the array F expressed in bytes are converted into values in the range 0 to y−1. It will thus be appreciated that the scaling factor sf can be calculated at any time prior to step S51 where byte values are converted into scaled integer values using the scaling factor sf calculated as described above. That is, after the processing of step S51, all elements of the array F take one of y discrete values (in the range 0 to y−1), generated by dividing each element Fₙ by the computed scaling factor sf.

Referring back to FIG. 6, stage II processing carried out at step S23 is now described with reference to FIG. 9. It will be recalled that the processing of step S23 is carried out only if the value of k indicating a number of time slices is greater than twice the value of x, that is when each of the arrays F and G has been filled.

Referring to FIG. 9, at step S55 a check is carried out to determine whether the value of k is less than n times the value of x. It will be recalled that the value of n was initialised to 3 at step S17 of FIG. 5, such that on first execution of the processing of FIG. 9, the check of step S55 determines whether the value of k is less than three times the value of x. If the check of step S55 is satisfied processing passes to step S56 where the i^{th} element of the array G is assigned to the value dₖ (i.e. the quantity of data which passed through the switch during the currently processed time slice k). Processing passes from step S56 to step S57 where the value of the counter variable i is incremented, before processing passes to step S58, from where processing returns to step S24 of FIG. 6.

If the check of step S55 is not satisfied, it can be seen that each element of the array G has an assigned value, processing passes from step S55 to step S59 where a scaling process is carried out as described in further detail below with reference to FIGS. 10 and 11. Processing passes from step S59 to step S60 where the value of n indicating the number of times an array of size x has been filled is incremented, before the value of i is reset to 1 at step S61 and processing then passes to step S58.

It can be noted that the processing of step S59 is only carried out when the value of k is greater than twice the value of x given the check of step S21 (FIG. 6). Given that when the value of k is equal to twice the value of x the processing described with reference to FIG. 8 is carried out at step S34 of FIG. 7, it will be appreciated that the processing of S59 is only carried out when the array F has elements taking discrete values defined with reference to y.

The processing of step S59 is now described with reference to FIG. 10. At step S65 the integer values in the array F are converted to byte values by multiplying each element of F by the scaling factor sf. It will be appreciated that each byte value represents an approximate average amount of data seen in a respective time period associated with an element of the array F. At step S66 a new scaling factor is calculated. Calculation of the new scaling factor is described in further detail below with reference to FIG. 11. Processing passes from step S66 to step S67.

At step S67 and step S68 the values of the array F are updated and at step S69 these values are converted to integer values as described previously with reference to step S49, S50 and S51 of FIG. 8. That is, at step S67 values of the first x/2 elements of the array F are generated using all x elements of the array F according to equation (1), while at step S68, the second x/2 elements of the array F are generated from the array G according to equation (2).

The calculation of the scaling factor at step S66 of FIG. 10 is now described in further detail with reference to FIG. 11. At step S70 the variable g is assigned to the maximum value in the array G. At step S71 the scaling factor sf(G) is calculated for G by dividing g by one less than the number of data values, i.e. y−1 as described above with reference to step S43 of FIG. 8. At step S72 a value f is calculated by multiplying the scaling factor sf of the array F by y−1. Processing passes from step S72 to step S73 where a test is performed to determine if the number of time slices processed, k, is equal to three times the size of the arrays F and G. If it is determined that k is equal to three times the value of x then at step S74 a further test is performed to determine if g is greater than f If it is determined that g is greater than f then at step S75 a weight w is calculated by dividing the value of g by the value off and applying the function round to the result. Processing passes from step S75 to step S76 where the scaling factor is calculated according to equation (5):

$$sf = \frac{sf \cdot w + sf ( G )}{2} \qquad ( 5 )$$

It can be noted, in comparing equation (1) and equation (5), that sf in equation (5) is analogous to sf(F) in equation (1).

If the test of step S74 indicates that the value of g is not greater than the value of f processing passes from step S74 to step S77. At step S77 a weight w is calculated by dividing f by g and applying the function round to the result. Processing then passes to step S78 where the scaling factor is calculated according to equation (6):

$$sf = \frac{sf + w \cdot sf ( G )}{2} \qquad ( 6 )$$

Processing passes from each of steps S76 and S78 to step S79. The processing of step S79 is only carried out where sufficient time slices have been processed to provide 3x values. It is considered that after this number of time slices has been processed, enough data has been seen such that the mean and standard deviation of the maximum values seen in each previous array provides meaningful information about the data. It will be appreciated that in alternative embodiments it may be considered that a smaller or larger number of data slices should be processed before maximum values in the arrays are considered to provide meaningful data.

At step S79 the mean of the scaling factor values for each of the first three arrays is calculated. At step S80 the standard deviation of the scaling factor values seen in the first three arrays is calculated. Processing passes from step S80 to step S81 where processing returns to step S67 of FIG. 10.

If the test of step S73 determines that k is not equal to three times the value of x, processing passes to step S82. At step S82 a test is performed to determine if the value sf(G) is within a range bounded by an upper value generated by adding one standard deviation sd to the mean m and a lower value generated by subtracting one standard deviation sd from the mean m. If it is determined that sf(G) is not within the defined range then processing continues at step S83, where a further test is performed to determine if sf(G) is larger than m. If it is determined that sf(G) is not larger than m processing continues at step S84 where a weight is determined and at step S85 the scaling factor is calculated in the same way as at steps S77 and S78 as described above. Processing passes from step S85 to step S81, where processing returns to step S67 as described above.

If it is determined that sf(G) is larger than m at step S83, a weight w is calculated at step S86, and the scaling factor sf is calculated at step S87. It can be seen that the processing of steps S86 and S87 is analogous to that of steps S75 and S76 described above.

If it is determined at step S82 that the value of sf(G) is within the range defined with reference to the mean and standard deviation of the maximum values, processing passes from step S82 to step S88, where a check is again carried out to determine whether the value of sf(G) is greater than the value of m. If this check is satisfied, processing passes to step S86 and continues in the manner described above.

If the check of step S88 is not satisfied, that is if the value of sf(G) is not greater than the value of the mean m, processing passes from step S88 to step S89. At step S89 a weight w is calculated and at step S90 the scaling factor is calculated. The processing of steps S89 and S90 is analogous to that of steps S77 and S78 described above.

Processing passes from each of steps S87 and S90 to step S91. At step S91 the mean is updated to take into account the value of sf(G). Processing passes from step S91 to step S92 where the standard deviation of maximum values is similarly updated. Processing again passes from step S92 to step S81 where processing returns to step S67 as described above.

It can be seen from FIG. 10 that if the maximum value sf(G) for an array G falls below the lower bound of the range defined with reference to the mean and standard deviation then the value of sf(G) is not used to update the mean and standard deviation values (this is represented by the path through the flowchart of FIG. 11 involving steps S82 and S83). In all other cases the value sf(G) is used to update the mean and standard deviation of maximum values in the manner described above. By not updating the mean and standard deviation for small values in this way, the method further biases the data towards large values.

It will be appreciated in the above that the maximum value seen in an array can be used to calculate the mean in the place of the scaling factors of the arrays. If the maximum value in an array is used to calculate the mean then the tests of step S82, S83 and S88 are carried out with reference to the value g in the place of the value sf(G). It can be seen that using maximum values in the place of scaling factors for the above calculations is equivalent to multiplying all values by (y−1).

It can be seen that after each x time slices the array F stores x data points representative of the data passing through the switch 6 associated with a particular connection for the duration of the connection. After 3x time slices, and all subsequent values of n, the first x/2 data values of F will represent a longer period of time than the second x/2 data values given the scaling carried out as described above with reference to steps S67 and S68.

FIG. 12 shows processing carried out at step S9 of FIG. 4, when the end of a connection is identified. At step S95 a check is performed to determine if the number of time slices k is less than the size of the array F, x. If it is determined that k is less than x processing passes to step S96 where the maximum value in the array F is determined, and processing passes to step S97 where an appropriate scaling factor sf is calculated by dividing the value f by the value y−1. The values in the array F are scaled to integer values with reference toy at step S98 which is analogous to step S51 of FIG. 8 described above.

Processing passes from step S98 to step S99 where a check is carried out to determine if k is less than or equal to x/2. If it is determined that k is less than or equal to x/2 then at step S100 a variable p is assigned to the integer part of k/x, and processing passes to step S101. At step S101 the array F is populated with values as far as is possible by creating p versions of each value in F and assigning p elements of F to each value. For example if there are two data values in F at the end of the connection then the first half of the elements of F are assigned to the first data value and the second half of the elements of F are assigned to the second data value. In this case p is equal to x/2. An example of output data is shown in FIG. 13 where x is equal to 16 and at the end of the connection k is equal to 3 with integer values of 8, 15 and 8. In this case p is equal to the integer part of (16/3), that is 5, and it can be seen that in the output there are 5 versions of each integer value with the final value being set to zero.

If the test of step S95 indicates that k is not less than x processing passes from step S95 to step S102 where a test is performed to determine if k/x is an integer. If it is determined that this is the case then it can be seen that all values in the two arrays F and G have been processed as described above to give one array representative of all data values. This is because the number of time slices k is equal to an integer multiple of the value x. If it is determined that k/x is not an integer, then at step S103 a check is carried out to determine whether k is greater than 2x. If this is the case the two arrays F and G are processed and combined according to the processing of FIG. 8 at step S104 otherwise the two arrays are processed and combined according to the processing of FIG. 9 at step S105. In either case, unused elements of the array G are considered to have values of zero.

Processing passes from each of steps S99 (when the test is not satisfied), S101, S102, S104 and S105 to step S106. At step S106 it can be seen that the array F contains x scaled integer values which together represent the quantity of data which passed through the switch during the connection. The integer data values are converted into their binary representations at step S106 and at step S107 a string is created. FIG. 14 is an example of a string created by the network analysis module.

The created string comprises a first field 13 which indicates the number of data points x and number of values y. Given that in the described embodiment the values of x and y are equal it will be appreciated that a single value can be stored in the first field 13. A plurality of fields 14 indicate the values stored in the array F at the end of processing. The values 14 are all integer values in the range 0 to y−1 (or in some embodiments 1 to y). There is one field 14 for each value stored in the array F. In the example of FIG. 14 it can be seen that there are eight fields 14, indicating that the value of x is eight. It can be seen that each field stores a three bit number, meaning that each field can represent eight values. Given that y is equal to x it will be appreciated that storing three bit numbers in each of the fields 14 allows each of the values which may be stored in the array F to be represented. Two fields 15, 16 together represent the scaling factor of the array F. Given that the scaling factor of the array F will often be a relatively large number, the field 15 is used to store a value of the scaling factor while the field 16 stores a value indicating how the value of the field 15 should be scaled to generate the scaling factor of the array F.

In preferred embodiments of the invention, the output array F always includes at least one element having the maximum value determined by the value of y (i.e. y−1). It will be appreciated that when arrays are combined and scaling factors calculated in the manner described above, this might not always be achieved. For example, where the value of x and y is eight:

If a first array F is as follows:

F=[1,000,000; 10; 50; 10; 10; 50; 10; 10]

And a first array G is as follows:

G=[5,000; 6,000; 50; 10; 50; 30; 10; 10]

From the preceding description it will be appreciated that the scaling factor of the array F is given by:

$$sf ( F ) = ( \frac{Max ( F )}{7} ) = \frac{1 , 000 , 000}{7} = 142 , 857$$

While the scaling factor of the array G is given by:

$$sf ( G ) = ( \frac{Max ( G )}{7} ) = \frac{6 , 000}{7} = 857$$

The arrays F and G are combined in the manner described above to give a combined array F′ as follows:

$${F}^{′} = [ \begin{matrix}\frac{( 1 , 000 , 000 + 10 )}{2} ; \frac{( 50 + 10 )}{2} ; \frac{( 10 + 50 )}{2} ; \frac{( 10 + 10 )}{2} ; \\ \frac{( 5 , 000 + 6 , 000 )}{2} ; \frac{( 50 + 10 )}{2} ; \frac{( 50 + 30 )}{2} ; \frac{( 10 + 10 )}{2}\end{matrix} ]$$

$${F}^{′} = [ 500 , 005 ; 30 ; 30 ; 10 ; 5 , 500 ; 30 ; 40 ; 10 ]$$

The scaling factor of the combined array F′ is given by:

$$sf ( {F}^{′} ) = \frac{( 142 , 857 + 857 w )}{2} = 142988$$

$$where \text{:}$$

$$w = round ( \frac{142 , 857}{857} ) = 167$$

Thus, when the values in the array F′ are redefined with reference to the calculated scaling factor sf(F′) the resulting array F′ is:

F′=[3; 0; 0; 0; 0; 0; 0; 0]

Given that the array F′ does not include an element having the maximum value (i.e. an element having a value of seven), the element having the largest value (i.e. the first element, having a value of three) is identified, and values are scaled to set the element having the largest value to be equal to the maximum value (7). The values are scaled by taking the maximum value of the array F′ (3) and dividing the required maximum (i.e. the value y−1) by the maximum value of the array F′. For the array F′ above that is 7/3=2.33 which is defined to be a scaling value for the array. Values in the array are then multiplied by this scaling value to give a new scaled up array that contains a maximum value. The resulting array in the example above is therefore calculated to be:

F′=[7; 0; 0; 0; 0; 0; 0; 0]

The scaling factor of F′ is adjusted accordingly to ensure that multiplication of the maximum value, i.e. 7, in the array F′ still approximates to the maximum average amount of data seen in a given time interval that is represented by a value of the array. We therefore divide the scaling factor of F′ by the same scaling value used to scale up elements of F′ (in the above example from 3 to 7) that is 7/3=2.33. In the above example the scaling factor is calculated by round(142988/2.33)=61368. It can be seen that multiplication of the new scaling factor by the maximum value 7 gives approximately the same value as multiplication of the previous scaling factor by the previous maximum value 3, that is both give approximately 429,000. Maintaining the maximum value at the end of the connection in this way ensures greater accuracy for subsequent samples. This is because a larger maximum value results in a smaller scaling factor (since the largest value seen is approximated by the largest maximum value multiplied by the scaling factor) and a smaller scaling factor gives greater granularity for subsequent samples.

The processing carried out by the network traffic analysis module 12 will now be described with reference to a numerical example. For the purposes of the example the variables x and y both have values of 16. Processing is described with reference to six arrays of data points, that is k has a value of 16×6=96. The individual arrays processed have scaling factors as follows: 1152, 500, 750, 700, 10, 5500. The use and determination of the scaling factors is described in further detail below.

The example is illustrated by reference to FIG. 15 which shows the arrays that are created during the processing and how the arrays are combined in accordance with the processing described above. As described above some arrays store 16 raw byte values while some store 16 integer values which can be processed with reference to a scaling factor associated with the array. The scaling factors sf associated with each array are shown in FIG. 15.

The processing upon which the numerical example is based begins at step S1 of FIG. 4 where data indicating a new connection is received by the switch 6. At step S2 the network traffic analysis module is initialised. The time interval t is set to be 1 second while the number of data points x and a number of data values y are both equal to 16.

The processing of steps S3 to S7 of FIG. 4 is then repeated until data indicating the end of the connection is received. Steps S3 to S6 are performed repeatedly by the switch to forward received packets and packet headers to the appropriate ports, the network traffic analysis module 12 and the connection tracking module 11.

The processing of the network traffic analysis module at step S7 of FIG. 4 is now described in further detail with reference to the example of FIG. 15.

For the first 32 time slices, the test of step S21 FIG. 6 is satisfied and stage I processing is performed at step S22. Each time processing is performed the counter variable k is incremented at step S24 and the next time slice data, dₖ, is processed at step S20.

Referring now to FIG. 7, for the first k=16 time slices the test of step S25 is satisfied and the calculated data seen in each time slice dₖ is assigned to the kth element of the array F at step S26.

After the first 16 time slices have been processed the array F shown as A20 in FIG. 15 stores 16 values. The array F shown as A20 has a scaling factor of 1152. As the array F shown as A20 is the first array to be processed there is no scaling to be carried out and F remains as an array of 16 raw byte values, the maximum value of which is approximated to be 1152*15.

When k=17 the test of step S25 is not satisfied. At step S28 it can be seen that k=x+1 and at step S29 a counter i is initialised to the value 1 and at step S30 the value dₖ is assigned to the first element of the array G shown as A21 in FIG. 15. The counter i is incremented at step S31.

Processing of subsequent time slices where k is between 18 and 31 results in the tests of steps S25 and S28 not being satisfied but the test of step S32 being satisfied. These time slices are therefore processed at steps S30 and S31.

When k=32 none of the tests of steps S25, S28 and S32 are satisfied and processing passes to step S33 where the value dₖ is assigned to the final element of the array G shown as A21. The array G has a scaling factor of 500. At step S34 there are two full arrays, the array F shown as A20 and the array G shown as A21. The 32 time slices represented in the two arrays are processed to give 16 data points by the processing of FIG. 8 as indicated by processing P1. The processing P1 is performed by adding pairs of adjacent values from the array F (e.g. F1+F2, F3+F4) and dividing the results of the additions by two to give the first x/2 values for an array F shown as A22. The array G shown as A21 is similarly processed by adding pairs of adjacent values (e.g. G1+G2, G3+G4) and dividing the result of each addition by two to give a second x/2 values of the array F shown as A22. Each element of the array F shown as A22 gives an average raw byte value seen across a time period of 2t. The processing of P1 further comprises converting the raw byte values into values on a 0-15 scale using the scaling factor sf associated with the array F shown as A22.

Since the scaling factor of the array F shown as A20 (which scaling factor is 1152), is larger than the scaling factor of the array G shown as A21 (which scaling factor is 500) a weight and scaling factor are calculated at steps S47 and S48 as follows:

$$\frac{1152}{500} = round ( 2.3 ) = 2 = w$$

$$\frac{( 1152 + ( 500 * w ) )}{2} = \frac{( 1152 ( 500 * 2 ) )}{2} = 1076$$

So the scaling factor for the array F shown as A22 is 1076. Values in the array F shown as A22 are then converted into integer values in the range 0-15 based upon the determined scaling factor 1076.

For time slices k=32 onwards, the test of step S21 of FIG. 6 is not satisfied and stage II processing is carried out at step S23. Raw byte values are added to an array G shown as A23 according to the processing of FIGS. 6 and 9 until the test of step S55 of FIG. 9 is no longer satisfied. When this test is no longer satisfied it can be seen that the value k is equal to a multiple of the size of the arrays x and each element of the arrays F shown as A22 and the array G shown as A23 has been assigned a value. At step S59 processing is carried out according to FIGS. 10 and 11 where a scaling factor is calculated based on the existing scaling factor for the array F shown as A22 and the maximum value in the array of raw byte values G shown as A23. The processing of FIGS. 10 and 11 will now be described for the specific values given above.

When k=48 the array F shown as A22 has a scaling factor of 1076, while the array G shown as A23 has a scaling factor of 750.

The two arrays F shown as A22 and G shown as A23 are combined to provide one array F shown as A24, as indicated by processing P2. First, the integer values in the array F shown as A22 are multiplied by the scaling factor associated with the array F shown as A22 to generate byte values. Pairs of adjacent values in each of the array F shown as A22 and the array G shown as A23 are added together and divided by two as before, before being converted into integer values using the scaling factor for the array F shown as A24 which is now described.

Since k is now equal to 3.x, the test at step S73 of FIG. 11 is satisfied and a further test is performed at step S74 to determine whether the maximum value in the array G shown as A23 is greater than the maximum value in the array F shown as A22. In this case, since the scaling factor associated with the array G shown as A23 is 750, and the scaling factor associated with the array F shown as A22 is 1076 it can be deduced that the maximum value in the array G shown as A23 is not greater than the maximum value in the array F. Processing is therefore performed at steps S77 and S78 and the scaling factor is calculated at k=48 by the following:

$$\frac{1076}{750} = round ( 1.43 ) = 1 = w$$

$$\frac{( 1076 + ( 750 * w ) )}{2} = \frac{( 1076 + 750 )}{2} = 913$$

So the scaling factor for the array F shown as A24 is 913. Values in the array F shown as A24 are then converted into integer values with reference to the calculated scaling factor for the array F shown as A24. At steps S79 and S80 the mean and standard deviation of all scaling factors based upon raw byte values (rather than being computed with reference to other scaling factors) are calculated, that is:

mean(1152, 500, 750)=800

sd(1152, 500, 750)=268

When k=64 (i.e. data associated with sixty-four time slices has been processed) the array F shown as A24 of integer values has a scaling factor of 913 (computed as described above) and the array G shown as A25 has a scaling factor of 700 computed using the methods described above, specifically by dividing the largest byte value in the array G shown as A25 by fifteen (i.e. the value of y−1).

The two arrays F shown as A24 and G shown as A25 are contracted into one array, F shown as A26, using processing as described above as indicated by P3.

Since k is not equal to 3.x, at step S82 of FIG. 11 a test is performed to determine if the scaling factor of the array G shown as A25 which has a value of 700, is within one standard deviation of the mean of the scaling factors of the arrays in which raw data values were stored (i.e. the array F shown as A20, the array G shown as A21 and the array G shown as A23). Since the scaling factor of the array G shown as A25 (700) is within one standard deviation (i.e. within 268) of the calculated mean (800), the test is satisfied. A further test is performed at step S88 to determine if the scaling factor of the array G shown as A25 is greater than the calculated mean. Since 700 is not larger than 800, processing is carried out at steps S89 and S90 and the calculation is as before, that is:

$$\frac{913}{700} = round ( 1.3 ) = 1 = w$$

$$\frac{( 913 + ( 700 * w ) )}{2} = 806$$

So the scaling factor for the array F shown as A26 and generated by combining the array F shown as A24 and the array G shown as A25 is 806.

Values in the array F shown as A26 are converted into integer values as before with reference to the calculated scaling factor 806. The mean and standard deviation are updated at steps S91 and S92, now based upon the scaling factors of all processed arrays of raw byte values. That is:

mean(1152, 500, 750, 700)=775

sd(1152, 500, 750, 700)=236.

When k=80 the array F shown as A26 has a scaling factor of 806 (calculated as described above) and the array G shown as A27 has a scaling factor of 10.

The arrays F shown as A26 and G shown as A27 are contracted into one array, F shown as A28, by processing indicated as P4.

Since the scaling factor of the array G shown as A27 is neither within one standard deviation (236) of the calculated mean (775) nor larger than the calculated mean, the tests of steps S82 and S83 of FIG. 11 are both not satisfied and processing is performed at steps S84 and S85.

The scaling factor for the array F shown as A28 is therefore calculated as follows:

$$\frac{806}{10} = round ( 80.6 ) = 81 = w$$

$$\frac{806 + ( 10 * w )}{2} = \frac{( 806 + ( 10 * 81 ) )}{2} = 808$$

So the scaling factor for the array F shown as A28 is 808. Values in the array F shown as A28 are converted into integer values as before with reference to the calculated scaling factor. In this instance the mean and standard deviation are not updated using the scaling factor of the array G shown as A 27, since the scaling factor of the array G shown as A27 is neither within one standard deviation of the mean nor larger than the mean.

When k=96 the array F shown as A28 has a scaling factor of 808 (calculated as described above) and the array G shown as A29 has a scaling factor of 5500.

The arrays F shown as A28 and G shown as A29 are combined into an array F shown as A30 using the processing PS which is as described above.

Since k is greater than 3n the mean and standard deviation of the previous scaling factors as calculated previously are required for the test of step S82 of FIG. 11. Since the previously processed array (the array G shown as A27) has a scaling factor of 10 which is outside one standard deviation of the mean, the scaling factor of the array G shown as A27 is not used to generate the mean and standard deviation. The mean and standard deviation therefore remain as previously calculated, that is:

mean(1152, 500, 750, 700)=775

sd(1152, 500, 750, 700)=236

The scaling factor of the array G shown as A29 is 5500 which is not within one standard deviation of the mean and is greater than the mean so processing is carried out by steps S86 and S87 of FIG. 11 as shown below to calculate a scaling factor for the array F shown as A30.

$$\frac{5500}{808} = round ( 6.8 ) = w$$

$$\frac{( 5500 + ( 7 * 808 ) )}{2} = 5578$$

so the scaling factor associated with the array F shown as A30 is 5578.

Values in the array F shown as A30 are converted into integer values as before with reference to the computed scaling factor. The mean and standard deviation are updated according to the new value of 5500. Due to this new very large value, previous values become very small on the 0-15 range.

If data indicating the end of the connection is received then the final processing of step S9 FIG. 4 is performed as shown in FIG. 12. In the example described above, the connection close is received when the value of k is equal to 96. Referring now to FIG. 12, since the value of x is 16 and 96 divided by 16 is 6 which is an integer, processing passes to step S104 and is carried out as described above.

The data that is output from the connection tracking module 11 to the database 7 can be used to generate a graph representing the connection, examples of which are shown in FIGS. 13 and 16. These graphs can be produced by processing the string that is output from the network traffic analysis module since the order in which the elements of the string are concatenated is known. Further information can be obtained from data output from the connection tracking module including details of when the connection began and ended and which two computers the connection was between.

Referring now to FIG. 16, from the data output by the network traffic analysis algorithm described above it can be seen that the value of each point Ti of the graph represents the average amount of data seen over a particular time period. The first x/2 values will in general be averaged over a longer period of time (for k greater than 2x), but will still always be an average over the particular time interval.

The output graphs of the form shown in FIGS. 13 and 16, and the data represented by the graphs, can be used to perform a number of network analysis functions including routing analysis, security management, bandwidth management and network analysis. These functions are described in further detail below.

Routing analysis can be used to select an optimal connection to be used for key data transmissions. If a network has three links available between two points, the data generated by the network traffic analysis module relating to each of the three links can be used to determine which of the three links has the best performance. Performance can be measured against a number of criteria such as which connection has the shortest time for sending a particular amount of data, and which connection allowed the largest amount of data to flow in a given time period. This can be seen from the output data, as the maximum amount of data seen in a time period is the value sf which is output as a parameter of the string described with reference to FIG. 14.

Security issues within a network can be analysed by inspection of the output graph generated from the network traffic analysis module (or data used to create such a graph). If a connection has a regular distribution of data values for all but one of the data points, and one data point that is exceptionally high, this could indicate that an attack occurred on the network. The output graph can therefore indicate connections that require further investigation. Since the network traffic analysis method outputs data at the end of each connection, high risk connections can be identified very quickly and further information can be obtained. Similarly if a large majority of connections result in largely similar data being output from the network traffic analysis method but some connections generate anomalous output data, this might indicate that connections having anomalous output data should be investigated further.

It is possible to identify from the connection data output graphs those times at which the network experienced very high levels of data flow. From this the capacity required from the network can be predicted for future connections and therefore managed by providing extra bandwidth at these key times.

An example of analysis of a network as a standalone application using the graph generated from the output of the network traffic analysis method is change management. If a change is made to a network topology aimed at maximising data throughput whilst minimising transfer times, the effectiveness of the change can be determined by analysing the data obtained using the network traffic analysis method before and after the change is made. The topology that provides the highest peaks and the maximum data flow seen in a time period can be seen to be the most effective configuration. The ideal is to have a constant distribution of data values indicating that a connection behaves consistently and therefore provides predictable network performance.

In an alternate embodiment, a graph number representing a graph shape may be stored together with the scaling factor. The graph number is a means of representing the network traffic analysis data and is used in the place of the string created by the network analysis module, such as that shown in FIG. 14 and described previously. Examples of possible graph numbers and the shapes they represent, for the case where x and y are both equal to 4, are shown in FIG. 16A.

The graph number may be used in conjunction with a look up table, which can be used to determine the data points that correspond to a particular graph number. An example look up table is shown in FIG. 16B for the case where x and y are both equal to 4. For each graph number there is a corresponding 4 digit data point value. It can be noted that each graph number contains at least one maximum data point value. In the case where y is 4 as in FIG. 16B, that is a value 3. From a particular graph number the corresponding data values can be looked up and a graph shape can be deduced from the looked up data values. It can be seen that the graphs of FIG. 16A correspond to the data values of Table 1 for their particular graph number.

Graph numbering can be performed in a number of different ways, and the way described above is exemplary only.

The number of required graph numbers can be calculated for any given x, y values. Since each graph must contain a maximum data value, the number of required graph numbers gn is calculated according to equation (7) where x is the number of data points and y is the number of discrete data values each data point can take.

gn=y^{x}−(y−1)^{x} (7)

The value y^{x} is the total number of possible graphs given x data points and y values each data point can take. The value (y−1)^{x} is the total number of possible graphs where there is no maximum value, that is y−1. It can be seen therefore that gn is the total number of graphs in which there is at least one maximum data value.

Determination of the graph number can be performed in a number of different ways. One method would be to calculate an array of data values according to the method described above and convert this to a graph number. Conversion to a graph number could occur at the end of a connection or alternatively it could be calculated each time scaling is performed to derive the array F.

Alternative methods of determining a graph number for a connection, or part of a connection will now be described.

Data passing through the connection may be sampled at a predetermined interval t and stored, for example in an array F where the array F is of sufficient size to store the maximum possible number of data points for a connection. At the end of the connection the sampled data is compressed into x data points, each data point taking a possible value in the range 0 to y−1.

Compression may be performed by dividing an array F into x blocks of consecutively recorded elements, where x is the number of data points. A quantity d is calculated by dividing the number of elements of F by the required number of data points, x and taking the integer part, that is d=int(|F|/x). A further value e is calculated by taking the remainder of the division used to calculate d. The value d is the minimum number of elements of F in each block. The last e blocks each contain d+1 elements of F. It can therefore be seen that all elements of F are added to a block, with at most a difference of one in the number of elements in any block that is used to calculate a particular data point.

In an alternate embodiment the e remaining elements can all be added to the final block.

The data elements in each block are summed to give x single values s, each single value s being indicative of the total quantity of data seen in a time period represented by a block. It can be seen that the time period represented by a value s is equal to either (|F|/x)*t or ((|F|/x)+1)*t for the last e values s in the case where (|F|/x) is not an integer.

The maximum s value is selected and divided by y−1, where y is the number of data values. The integer part of this value is the scaling factor. The scaling factor is used to scale the s values to give x scaled data values. The scaled data values can be retained, or can be converted to give a graph number as described above.

In the following example the number of data points, x, and the number of values, y, are both equal to 4. The number of samples at the end of the connection is 17. The raw data values are:

F={1;3;6;8;8;8;3;2;6;7;9;9;9;0;1;2;1}

The value d is calculated by int(17/4)=4 and the value e is 1. Thus the first 3 blocks contain 4 consecutive elements of the array F representing 4 contiguous data samples, and the final block contains the last 5 elements of the array F. The blocks and corresponding block totals, s, are therefore given by:

B1={1;3;6;8}=18

B2={8;8;3;2}=21

B3={6;7;9;9}=31

B4={9;0;1;2;1}=13

The maximum block total is 31, corresponding to block B3 and the scaling factor is therefore round(31/(4−1))=10. Scaling each block value gives the resulting output values as {1;2;3;1} This value can be converted to the graph number 55 using the look up table of FIG. 16b.

In a further embodiment, a graph number indicative of a graph shape may be output during a connection at fixed sample intervals, irrespective of whether the connection continues or terminates. After a fixed time interval a given number of samples n will have been taken. The number of samples n is divided into x blocks of consecutive samples, with each block containing n/x data samples. The data values for each block are totalled to give x raw data values. These raw data values can be scaled using a scaling factor calculated with respect to the maximum totalled raw data value as described previously, that is by calculating the scaling factor sf by dividing the maximum raw data value by y−1 and scaling each data value by this value.

In the following example the number of samples is 24 (i.e. 24 raw data values have been received) and the number of data points, x, and the number of values, y, are both 4. The number of samples in each block is calculated to be 24/4=6. After 24 samples the following 24 raw data values are collected:

F={1;3;6;8;8;8;3;2;6;7;9;9;9;0;1;2;1;0;0;0; 0;0;0;0}

The first block is {1;3;6;8;8;8} and the total is therefore 34. The second block is {3;2;6;7;9;9} and the total is therefore 36. The third block is {9;0;1;2;1;0} and the total is therefore 13. The fourth block is {0; 0;0;0;0} and the total is therefore 0.

The scaling factor sf is calculated by dividing the maximum value of the totals of the processed blocks by y−1, that is sf=round(36/3)=12. The values obtained for each block are then scaled according to sf to give the final array {3;3;1;0}. This can be converted to a corresponding graph number by looking up in a suitable table such as FIG. 16B.

Whilst the above alternative methods of determining data representative of a connection are described with respect to outputting a graph number, the same methods could be used to output an array representing the connection by not performing the final look up conversion. That is, data of the form described with reference to FIG. 14 may be output.

When data is sent between two computers in the network of FIG. 1 it is desirable to send as little data as possible. Sending a checksum without its corresponding data is advantageous as it reduces the amount of data sent across a network and can reduce bandwidth requirements as well as reducing send times. However, a particular checksum may not be unique to a particular data item and sending only the checksum of a data item is therefore, in general, not sufficient to allow a receiver to uniquely identify the data which the sender intended to send. It is possible to divide a data item into secondary component data items. Checksums for the secondary data items can also be calculated.

The inventors have realised that by storing the checksum of a data item together with the checksums of secondary data items derived from the original data item, it is possible to use the checksums of secondary data items as a second level check. The data corresponding to the checksums can be stored in a library with the checksums. If it is known that a computer to which data is to be sent has a library storing data together with checksums as described above, it is possible to send only the checksums. The receiving computer is able to perform a checksum data lookup and in this way retrieve the data without requiring the data to be sent across the network.

FIG. 17 shows data stored in databases 101, 102 which are respectively associated with the computers 1, 2 (FIG. 2). A data item A has a checksum 103 which is stored in the database 101. The data item A is made up of a first data item A1 having a checksum 104 and a second data item A2 having a checksum 105. The database 101 stores the checksums 103, 104, 105 associated with the respective data items.

The database 102 stores equivalent checksums. That is, a checksum 106 is stored in association with the data item A, a checksum 107 is stored in association with the data item A1 and a checksum 108 is stored in association with the data item A2.

When the computer 1 wishes to send the data item A to the computer 2, instead of sending the data item A itself, the computer 1 sends the checksums of each of the data items A, A1 and A2. On receipt of these checksums, the computer 2 can match the received checksums with the stored checksums so as to identify that the data which the computer 1 wished to transmit to the computer 2 was the data item A.

It will be appreciated that the data can be transmitted in accordance with the method described with reference to FIG. 17 only if the computers 1, 2 have knowledge of the data stored in the database associated with the other computer. It is preferred that each of the databases 101, 102 is initially empty, and processing is therefore carried out to store appropriate data in the databases 101, 102 based upon data commonly transmitted between the computers 1, 2. It will be appreciated that where data is also transmitted from the computer 1 to the computer 3, the computer 1 will store in the database 101 data indicating the data stored in the database associated with the computer 3.

Processing carried out to allow checksums to be used as described above is now described with reference to FIG. 18. At step S110 data to be sent from the computer 1 to the computer 2 of FIG. 2 is stored in a buffer associated with the computer 1. The data stored in the buffer is referred to as a data item. At step S111 the checksum of the data item is calculated. At step S112 the data item in the buffer is divided into secondary data items and checksums of the secondary data items are calculated. The data item may be divided into secondary data items in any convenient way. For example, considering the data item as a string of length N, a first N/2 elements of the string may make up a first secondary data item while a second N/2 elements of the string may make up a second secondary data item.

At step S113 a check is carried out to determine whether the calculated checksums for both the data item and its secondary data items are stored in the database 101 associated with the computer 1 from which the data is to be sent. FIG. 19 schematically shows the form of records stored in the database 101. Each record comprises a checksums field 110 storing checksums for a data item and its secondary data items. A plurality of count fields 111 each indicate a number of times which data associated with the checksums field 110 has been sent to a respective computer from the computer 1. A data field 112 (if populated) stores the data item associated with the checksums indicated by the checksums field 110.

The check of step S113 determines whether a record of the database 101 stores the combination of checksums calculated at steps S111 and S112 in the field 110. If it is determined that there is not a matching set of checksums in the database 101 processing passes to step S114 where a record of the database based upon the combination of checksums is created. The created record of the database 101 stores the calculated checksums in the checksums field 110. At step S115 data indicating that data associated with the calculated checksums was to be sent to a particular computer is stored by incrementing one of the count fields 111. At step S116 a check is carried out to determine whether the relevant count field 111 has reached a predetermined value indicating that the data associated with the respective checksum field 110 has been transmitted the predetermined number of times. If this is not the case, processing passes to step S117 where the relevant data (not the associated checksums) is transmitted. If however the check of step S116 indicates that the value of the relevant count field 111 has reached the predetermined value, processing passes to step S118 where the data field 112 of the relevant record of the database 101 is populated with the data associated with the checksums stored in the relevant checksums field 110, before processing continues at step S117 as described above.

If the check of step S13 indicates that the checksums generated from the data item and its secondary data items do match a record of the database 101, processing passes from step S113 to step S119. At step S119 a check is carried out to determine whether the data field 112 of the relevant record of the database 101 is populated. If this is not the case processing passes from step S119 to step S115 and continues as described above. If the check of step S119 is satisfied, processing passes from step S119 to step S120. Given that the computer 1 assumes that where data associated with particular checksums is stored in the database 101, similar data will be stored in the database 102, if the check of step S119 is satisfied, the computer 1 assumes that the computer 2 will be able to retrieve data associated with the checksums from the database 102. As such, at step S120 the checksums are transmitted from the computer 1 to the computer 2. The transmitted checksums are received by the computer 2 at step S121. At step S122 the computer 2 determines whether the data associated with the received checksums from the database 102 can be retrieved. If this check is not satisfied, processing passes from step S122 to step S123 where the computer 2 transmits a request to the computer 1 for the relevant data, which is subsequently transmitted by the computer 1 and received by the computer 2. If the check of step S122 is satisfied, processing passes to step S124 where the relevant data is retrieved from the database 102.

It has been described above that the computer 1 assumes that the data stored in the database 101 in association with particular checksums is also stored in the database 102. The database 102 stores records having the same general form as those stored in the database 101 and described above with reference to FIG. 19. Processing carried out by the computer 2 to allow such an assumption to hold true is now described with reference to FIG. 20. At step S130 a data packet is received by the computer 2. At step S131 a check is carried out to determine whether the received data packet contains data or checksums. If the check of step S131 indicates that the received data packet comprises data, processing passes from step S131 to step S132 where a checksum for the received data item is calculated. At step S133 the data item is processed in a predetermined way to generate secondary data items as described above, and checksums of the secondary data items are calculated. Processing passes from step S133 to step S134 where a check is made to determine whether the calculated checksums are stored in the database 102 associated with the computer 2. If this check is not satisfied processing passes from step S134 to step S135 where a new record is created in the database 102. The new record created in the database 102 contains the calculated checksums. Processing then passes to step S136 where a count field associated with the computer 1 from which the data was received is incremented. Processing passes directly from step S134 to step S136 where it is determined that the calculated checksums are stored in the database 102.

Processing passes from step S136 to step S137 where a check is carried out to determine whether the relevant count field has reached a predetermined value. If this is the case the data associated with the checksums is stored in the database at step S138, before the received data is processed at step S139. Otherwise, processing passes directly from step S137 to step S139. In this way it can be seen that data associated with particular checksums is stored in the database 102 associated with the computer 2 when the relevant count field reaches the predetermined value indicating that the particular data has been received a predetermined number of times. In this way it can be seen that data is stored in the database 101 associated with the computer 1 at step S118 and in the database 102 associated with the computer 2 at step S138 in response to the same transmission of data between the computer 1 and the computer 2.

If the check of step S131 determines that the data packet received at step S130 comprises checksums rather than data, the computer 2 attempts to retrieve the relevant data based upon the received checksums. Processing therefore passes from step S131 to step S140 where a check is carried out to determine whether the required data is stored. If this check is satisfied, processing passes from step S140 to step S141 where the relevant data is retrieved from the database before the data is processed at step S139.

If the check of step S140 indicates that the required data is not stored, processing passes from step S140 to step S142 where the appropriate data is requested from the computer 1. Processing then returns to step S130 where the computer 2 waits for receipt of an appropriate data packet.

The preceding description has discussed the use of checksums. It will be appreciated that embodiments of the invention can use any suitable checksum calculation, including, for example a cyclic redundancy check checksum calculation.

The above description has focussed upon a transmission of data from the computer 1 to the computer 2. It will be appreciated that many applications will require bidirectional data transfer between the computers 1, 2 such that the processing described both with reference to FIGS. 18 and with reference to FIG. 20 is carried out by each of the computers 1, 2 such that each computer can transmit data to the other. Indeed, in a networked computer system in which a plurality of computer systems transmit data between one another, each computer will carry out processing according to both of FIGS. 18 and 20, and each computer will have a database storing records having the general form shown in FIG. 19.

In the preceding description it has been explained that a particular data item is processed to generate two secondary data items for which checksums are calculated. It will be appreciated that in alternative embodiments of the invention a data item may be processed so as to generate a different number of data items. Furthermore, the generated secondary data items may themselves be processed so as to generate tertiary data items. Checksums for the tertiary data items can then be calculated, and a particular data item can be associated with its checksum as well as checksums of its secondary and tertiary data items.

From the preceding paragraph it will be appreciated that in different embodiments of the invention a data item may be processed in any convenient way to generate a plurality of secondary data items, and the secondary data items may themselves be processed to generate a plurality of tertiary data items. It will further be appreciated that the tertiary data items may themselves be processed to generate a plurality of data items, and so on. That is, referring to FIG. 17, while the illustrated arrangement of checksums 103, 104, 105 may be considered to be a two-level hierarchy, a hierarchy with any number of levels may be used in alternative embodiments of the invention.

Where the computers 1, 2 transmit data between one another, it will sometimes be the case that received data includes one or more errors. It is desirable that a computer receiving data including errors is able to correct those errors, preferably without requesting further data. FIG. 21 shows a transmission of data between the computers 1, 2. It can be seen that data 120 is transmitted from the computer 1 to the computer 2. The computer 1 also transmits error correction data 121 to the computer 2. The computer 2 is configured to process the received data 120 and the received error correction data 121 and correct any errors in the received data using known methods such as triple modular redundancy or forward error correction methods such as hamming codes.

It can further be seen that the computer 1 also sends a data integrity checksum 122 to the computer 2. The data integrity checksum is in general sent as part of the data 120. This data is provided to the computer 2 to ensure that the received data 120 is correct, that is, the received data matches the sent data. The inventors have realised that this data integrity checksum can be used in conjunction with the error correction data to correct errors where the error correction data is not sufficient. This process is now described with reference to the flowchart of FIG. 22.

At step S150 the computer 1 transmits the data 120 together with the data integrity checksum 122 to the computer 2. At step S151 the computer 1 transmits the error correction data 121 to the computer 2. The data 120 together with the data integrity checksum 122 is received at the computer 2 at step S152, while the error correction data 121 is received at the computer 2 at step S153. While the error correction data 121 is described as being sent after the data 120, it will be appreciated that the error correction data 121 and data 120 may be sent in any convenient order, or the error correction data 121 may be interleaved with the data 120.

At step S154 the computer 2 attempts to correct errors in the data 120 using the error correction data 121. At step S155 a check is carried out to determine whether corrections made at step S154 are supported by the data integrity checksum 155. A correction is supported by the data integrity checksum if the checksum of the data matches the data integrity checksum. If the check of step S155 is satisfied, processing passes to step S156 where the corrected data is used. Otherwise, processing passes from step S155 to step S157 where a check is performed to determine if more corrections should be attempted. If it is determined that more corrections should be attempted then at step S158 the error correction data 121 tries the next most likely correction, for example the error correction with the next smallest hamming distance. Processing passes to step S155 where the correction is again checked to determine if the correction made at step S157 is supported by the data integrity checksum.

If the check of step S157 is not satisfied then processing passes to step S159 where the computer 2 may request the data to be resent from computer 1.

It can be appreciated from the foregoing description that the use of the data integrity checksum 122 ensures that corrections to the data 120 based upon the correction data 121 are only used if such corrections are in accordance with the data integrity checksum 122. Thus, it will sometimes be the case that the error correction algorithms using the error correction data 121 are such that incorrect corrections are made to the data 120. Such incorrect corrections are not used given that they are not in accordance with the data integrity checksum 122. The error correction data allows additional corrections to be made when a first correction fails rather than using incorrect data. In this way the two layers of the error correction, that is the data integrity checksum and the error correction data, are used together until both layers confirm that the correction to the data is acceptable.

It will be appreciated that references in the preceding description to quantities of data being measured in bytes are exemplary. Quantities of data can be measured in any convenient way, including being measured in bits or bytes.

It will be appreciated that the embodiments described above are merely exemplary and the various modifications can be made to the described embodiments without departing from the scope of the appended claims. It will further be appreciated that the various components described above can be implemented in any suitable way. For example, components of the switch 6 can be implemented in any convenient form including hardware or software. Finally, it will be appreciated that the term “computer” as used herein in intended broadly to refer to any device capable of sending and/or receiving data over a communications network.

1. A computer implemented method for analysing a connection between two computers, the method comprising generating output data indicating performance of the connection, the output data comprising a first predetermined number of data points, each data point having a value selected from a second predetermined number of discrete data values.

2. A method according to claim 1 wherein said generating comprises:
storing a third number of initial values, each initial value indicating a quantity of data passing between said two computers in a predetermined time period.

3. A method according to claim 2 wherein said generating further comprises:
processing said third number of stored initial values to compute a fourth number of processed values wherein said fourth number is smaller than said third number.

4. A method according to claim 3 wherein said fourth number is equal to said first predetermined number.

5. A method according to claim 3 wherein computing each of said fourth number of processed values comprises computing an average value based upon a plurality of said stored inital values.

6. A method according to claim 5 wherein computing said fourth number of processed values further comprises:
determining a first scaling factor;and
determining a relationship between each of said average values and said first scaling factor.

7. A method according to claim 6 wherein determining a first scaling factor comprises:
determining a maximum value; and
determining a relationship between said maximum value and the second predetermined number of discrete data values.

8. A method according to claim 6 wherein said output data further comprises said first scaling factor.

9. A method according to claim 3, further comprising: storing a fifth number of further initial data values;
computing modified processed values based upon said processed values and said further initial data values.

10. A method according to claim 9 wherein said fifth number is equal to said fourth number.

11. A method according to claim 9 wherein computing modified processed values based upon said processed values and said further initial data values comprises:
processing said further initial data values to determine a second scaling factor;
computing a modified scaling factor based upon at least one first scaling factor associated with said processed values and said second scaling factor; and
determining a relationship between a plurality of said processed values and said further initial data values and said modified scaling factor.

12. A method according to claim 11 wherein said relationship is based upon an average of a plurality of said processed values and said further initial data values.

13. A method according to claim 11 wherein computing a modified scaling factor is based upon an average of a plurality of first scaling factors and said second scaling factor.

14. A method according to claim 11, wherein computing a modified scaling factor based upon said first scaling factor and said second scaling factor comprises:
determining a weight based upon a relationship between said first scaling factor and said second scaling factor;
computing a weighted average of said first scaling factor and said second scaling factor based upon said weight.

15. A method according to claim 14 wherein computing the modified scaling factor comprises applying said weight to one of said first scaling factor and said second scaling factor to produce a weighted scaling factor such that the weighted scaling factor is of substantially the same magnitude as the other of said first scaling factor and said second scaling factor.

16. A method according to claim 14 wherein said relationship between said first scaling factor and said second scaling factor is based upon division of one of said first scaling factor and said second scaling factor divided by the other of said first scaling factor and said second scaling factor.

17. A method according to claim 14, wherein said weight is applied to the smaller of said first scaling factor and said second scaling factor.

18. A method according to claim 11 wherein determining a relationship between a plurality of said fourth number of processed values and said further initial data values and said modified scaling factor comprises:
computing further processed data values based upon a relationship between said processed values and said first scaling factor;
computing a plurality of average values, each average value being based upon a plurality of said further processed values or a plurality of said further initial data values; and
determining a relationship between each average value and said modified scaling factor.

19. A method according to claim 11 further comprising:
storing said first scaling factor in a memory location; and
overwriting said first scaling factor with said modified scaling factor.

20. A method according to claim 9 further comprising:
storing said fourth number of processed data values in a memory location; and
overwriting said fourth number of processed data values with said modified processed data values.

21. A method according to claim 9, further comprising:
repeating the steps of:
storing a predetermined number of further initial data values;
computing modified processed values based upon said fourth number of processed values and said further initial data values.

22. A method according to claim 1 wherein said predetermined number of processed values is the same as said predetermined number of further initial data values.

23. A method according to claim 1 wherein at least one of said data points has a value indicative of said predetermined second number of discrete data values.

24. A method according to claim 1 wherein said output data is a graphical representation of said data.

25. A method according to claim 1 wherein said output data comprises a value indicative of said data points and data values and said data points and data values can be retrieved by a lookup table.

26. A method for identifying an anomalous connection in a plurality of connections, the method comprising analysing each of said plurality of connections by generating output data indicating performance of each connection, the output data comprising a first predetermined number of data points, each data point having a value selected from a second predetermined number of discrete data values, and identifying said anomalous connection by processing said output data.

27. A method according to claim 26 wherein identifying said anomalous output data comprises comparing peak values of the output data associated with each of said plurality of connections.

28. A method for generating data identifying a preferred configuration for a network, the method comprising:
configuring the network according to a first configuration;
analysing the network configured according to the first configuration by generating first output data indicating performance of each connection, the first output data comprising a first predetermined number of data points, each data point having a value selected from a second predetermined number of discrete data values;
configuring the network according to a second configuration;
analysing the network configured according to the second configuration by generating second output data indicating performance of each connection, the second output data comprising a third predetermined number of data points, each data point having a value selected from a fourth predetermined number of discrete data values;
processing said first and second output data to generate said data identifying the preferred configuration.

29. A method according to claim 1 further comprising:
receiving a plurality of data packets associated with said connection; and
processing said data packets to generate data indicating a quantity of data transferred using said connection.

30. A computer program comprising computer readable instructions configured to cause a computer to carry out a method for analysing a connection between two computers, the method comprising generating output data indicating performance of the connection, the output data comprising a first predetermined number of data points, each data point having a value selected from a second predetermined number of discrete data values.

31. A computer readable medium carrying a computer program configured to cause a computer to carry out a method for analysing a connection between two computers, the method comprising generating output data indicating performance of the connection, the output data comprising a first predetermined number of data points, each data point having a value selected from a second predetermined number of discrete data values.

32. A computer apparatus for analysing a connection between two computers, the computer apparatus comprising:
a memory storing processor readable instructions; and
a processor arranged to read and execute instructions stored in said memory;
wherein said processor readable instructions comprise instructions arranged to control the computer to carry out a method comprising generating output data indicating performance of the connection, the output data comprising a first predetermined number of data points, each data point having a value selected from a second predetermined number of discrete data values.

33. A method for transferring data from a first computer to a second computer, the method comprising:
determining a checksum of a data item to be transmitted;
processing said data item to be transmitted to generate a plurality of secondary data items;
determining a plurality of secondary checksums, one for each secondary data item;
transmitting said checksum and said secondary checksums from said first computer to said second computer, such that said second computer can identify said data item based upon said checksum and secondary checksums.

34. A method according to claim 33 further comprising storing, at the first computer, a record for said data item, said record comprising said checksum of said data item and said plurality of secondary checksums.

35. A method according to claim 34 wherein said record further comprises:
a value indicating the number of times said data item has been transmitted to said second computer.

36. A method according to claim 35 wherein transmitting said checksum and said secondary checksums comprises:
determining, at the first computer, whether said data item should be sent to said second computer based upon said value indicating the number of times said data item has been transmitted to said second computer; and
transmitting said data item to said second computer if it is determined that said data item should be transmitted to said second computer;
transmitting said checksum and said secondary checksums to said second computer when it is determined that said data item should not be transmitted to said second computer.

37. A method for receiving data at a second computer from a first computer, the method comprising:
receiving a checksum of a data item;
receiving a plurality of secondary checksums;
identifying said data item based upon said checksum and secondary checksums.

38. A method according to claim 37 further comprising storing a record for a received data item, said record comprising:
a checksum of said data item; and
a plurality of secondary checksums.

39. A method according to claim 38 wherein said record further comprises:
a value indicating the number of times said data item has been received from said first computer.

40. A method according to claim 39 wherein identifying said data item based upon said checksum and secondary checksums comprises:
determining whether said data item is stored based upon said value indicating the number of times said data has been received; and
requesting said data item from said first computer dependent upon said determining.

41. A computer program comprising computer readable instructions configured to cause a computer to carry out a method for transferring data from a first computer to a second computer, the method comprising:
determining a checksum of a data item to be transmitted;
processing said data item to be transmitted to generate a plurality of secondary data items;
determining a plurality of secondary checksums, one for each secondary data item;
transmitting said checksum and said secondary checksums from said first computer to said second computer, such that said second computer can identify said data item based upon said checksum and secondary checksums.

42. A computer readable medium carrying a computer program comprising computer readable instructions configured to cause a computer to carry out a method for transferring data from a first computer to a second computer, the method comprising:
determining a checksum of a data item to be transmitted;
processing said data item to be transmitted to generate a plurality of secondary data items;
determining a plurality of secondary checksums, one for each secondary data item;
transmitting said checksum and said secondary checksums from said first computer to said second computer, such that said second computer can identify said data item based upon said checksum and secondary checksums.

43. A method for receiving data, the method comprising:
receiving data;
receiving error correction data associated with the received data;
receiving secondary data associated with the received data;
processing said data and said error correction data to identify at least one error in the received data, and determine at least one correction to said error;
processing said secondary data to determine whether said at least one correction should be made.

44. A method according to claim 43 wherein said secondary data comprises a checksum for said data.

45. A method according to claim 43 further comprising:
determining a further correction to said error based upon said secondary data and said error correction data if it is determined said at least one correction should not be made.

46. A method according to claim 45 wherein said error correction data comprises an ordered list of corrections and determining a further correction comprises selecting the next correction in said ordered list.

47. A method according to claim 43 wherein said received data is hamming encoded.

48. A method according to claim 47 wherein said further correction is determined by the next smallest hamming distance.

49. Apparatus for receiving data configured to carry out a method for receiving data, the method comprising:
receiving data;
receiving error correction data associated with the received data;
receiving secondary data associated with the received data;
processing said data and said error correction data to identify at least one error in the received data, and determine at least one correction to said error;
processing said secondary data to determine whether said at least one correction should be made.
